(19) United States
(12) Patent Application Publication
(10) Pub. No.: US 2019/0211219 A1
(43) Pub. Date: Jul. 11, 2019

(54) INK COMPOSITION AND ORGANIC ELECTROLUMINESCENT ELEMENT USING THE SAME

(71) Applicant: JNC CORPORATION, Tokyo (JP)

(72) Inventors: Yasuhiro KONDO, Chiba (JP); Hiroshi ANRAKU, Chiba (JP)

(73) Assignee: JNC CORPORATION, Tokyo (JP)

(21) Appl. No.: 16/328,814

(22) PCT Filed: Aug. 21, 2017
(86) PCT No.: PCT/JP2017/029784

§ 371 Date: Feb. 27, 2019

(30) Foreign Application Priority Data
Sep. 15, 2016 (JP) 2016-180248
Apr. 4, 2017 (JP) 2017-074382

(51) Int. Cl. C09D 11/101; C09D 11/037; H05B 33/04; H05B 33/10

(52) U.S. Cl. CPC C09D 11/101; C09D 11/037; C09D 133/10; H05B 33/10; H05B 33/04

(57) ABSTRACT

Provided is an ink composition containing: as a first component, at least one inorganic filler having an average particle diameter of 1 to 30 nm; as a second component, at least one monomer selected from (meth)acrylate-based monomers; and as a third component, at least one polymerization initiator, in which the total weight concentration of the first to third components is 98 to 100% by weight relative to the total weight of the ink composition. The ink composition brings about a cured film having a high refractive index, a high transmittance, high flexibility, and/or a dielectric constant.

### TECHNICAL FIELD

The present invention relates to an ink composition useful as a sealing agent for an organic thin film device such as an organic electroluminescent element, preferably an ultraviolet curable resin composition, and an organic thin film device using a cured product thereof. More specifically, the present invention relates to an ink composition having a good film-forming property, good storage stability, and good inkjet ejection stability, a cured product having a high refractive index, a high transmittance, high flexibility, a low dielectric constant, high adhesion, high smoothness, high plasma resistance, and a good shielding property against moisture and oxygen, obtained from the composition, and an organic electroluminescent element including the cured product.

### BACKGROUND ART

The organic electroluminescent element is a self-luminous light emitting element and is expected as a light emitting element for display or illumination. The organic electroluminescent element made of an organic material has been actively studied because the organic electroluminescent element easily saves power, reduces the thickness, reduces the weight, increases the size, and becomes flexible.

The organic electroluminescent element has a structure having a pair of electrodes composed of a positive electrode and a negative electrode, and a single layer or a plurality of layers disposed between the pair of electrodes and containing an organic compound. The organic electroluminescent element is extremely easily deteriorated by moisture and oxygen, and causes, for example, peeling of a metal electrode from an organic material layer interface due to a reaction between the metal electrode and moisture, an increase in resistance due to oxidation of the metal electrode, or degeneration of an organic compound included in the organic electroluminescent element due to oxygen and moisture. Due to the deterioration, the luminance of the organic electroluminescent element is lowered. In the worst case, the organic electroluminescent element does not emit light and becomes a dark spot. (Non Patent Literature 1)

As a method for preventing such deterioration of the organic electroluminescent element due to moisture and oxygen, a method for covering (surface-sealing) the organic electroluminescent element with a sealing material is used. In the early stages of development of an organic EL display, an adsorbent of moisture and oxygen and a compound inert to the organic electroluminescent element were encapsulated in a display panel using glass or metal for sealing. However, sealing with glass or metal has a high sealing ability against moisture and oxygen, but does not have sufficient flexibility, and is not suitable for a flexible organic thin film device or a wearable organic thin film device.

Therefore, a method using a thin film was studied. For example, by precisely coating a top surface of a film with an inorganic material and/or an organic material, flexibility can be imparted to a sealing layer. In this case, by manufacturing an organic electroluminescent element and then further bonding a film coated with a sealing material thereto, an organic EL display panel can be manufactured. In addition, by precisely coating a top surface of an organic electroluminescent element with an inorganic material and/or an organic material, flexibility can be imparted to a sealing layer. In this case, a sealing layer is manufactured directly on the organic electroluminescent element or after a passivation layer is disposed (Non Patent Literature 2 or 3).

In general, if an organic material is used as a coating material, flexibility can be imparted but sealing performance is lowered. Conversely, if an inorganic material is used, the sealing performance is increased, but flexibility is lowered. Therefore, studies have been made to achieve both flexibility and sealing performance by thinly and alternately laminating an inorganic material and an organic material in several layers. However, as the number of layers to be laminated increases, the sealing performance increases, but the number of steps increases, and therefore economic efficiency often decreases.

In addition, since the refractive indexes of laminated films of an inorganic material and an organic material are different from each other, the transmittance of light may be low. This is a factor of deteriorating display performance of an organic EL display panel. There is an example in which a cured film having a high refractive index is provided using a thermosetting resin composition containing an inorganic filler, but it is predicted that a solvent contained therein will deteriorate an organic electroluminescent element (Patent Literature 1). In addition, use of a composition not containing a solvent in an organic electroluminescent element has been proposed (Patent Literatures 2 and 3), but it is not intended to improve the transmittance of light.

In recent years, due to demands for weight reduction, flexibility, and the like, a display device including an organic electroluminescent element and the like has been integrated with a touch sensor device such as a touch panel. For high speed operation and prevention of malfunction of the touch sensor device, a low dielectric constant is required for a sealing agent, a transparent insulating film, or an overcoat used therein.

### CITATION LIST

### Patent Literatures

### Patent Literature 1: Japanese Patent Application No. 2016-87933

### Patent Literature 2: JP 2009-506171 A

### Patent Literature 3: Japanese Patent Application No. 2015-85735

### Non Patent Literatures

### Non Patent Literature 1: Advanced Materials, 22, 3762-3777, 2010

### Non Patent Literature 2: Flexible OLED Report, 2014, UBI Research

### Non Patent Literature 3: SID 2016 (Short Course S-1) Fundamentals of Flexible OLEDs: A Practical Aspect of Flexible OLED Displays, 2016

### SUMMARY OF INVENTION

### Technical Problem

The present invention has been achieved in view of the above circumstances. An object of the present invention is to provide an ink composition which can be used as a sealing agent for an organic thin film device such as an organic electroluminescent element, preferably a solventless ultraviolet curable resin composition, and a cured product having a high refractive index, a high transmittance, high flexibility, and/or a low dielectric constant, manufactured using the composition.

### Solution to Problem

As a result of various studies in order to solve the above problems, the present inventors have found that the above-described object can be achieved by an ink composition containing an inorganic filler having an average particle diameter of 1 to 30 nm, a (meth)acrylate-based monomer, and a polymerization initiator, preferably containing no solvent, and have completed the present invention.

Item 1. An ink composition containing:

as a first component, at least one inorganic filler selected from the group consisting of zirconium oxide, titanium oxide, hafnium oxide, barium titanate, boron nitride, and cerium oxide, having an average particle diameter of 1 to 30 nm;

as a second component, at least one monomer selected from (meth)acrylate-based monomers; and

as a third component, at least one polymerization initiator, in which

the total weight concentration of the first to third components is 98 to 100% by weight relative to the total weight of the ink composition.

Item 2. The ink composition according to item 1, in which the first component is zirconium oxide.
Item 3. The ink composition according to item 1 or 2, in which the (meth)acrylate-based monomer as the second component has at least one selected from the group consisting of an alkyl group, an alkenyl group, an ether group, and an aryl group.
Item 4. The ink composition according to any one of items 1 to 3, in which the (meth)acrylate-based monomer as the second component contains at least one selected from the following compound group (2-a) and at least one selected from compound group (2-b).

Compound group (2-a): monofunctional (meth)acrylate-based monomer

Compound group (2-b): polyfunctional (meth)acrylate-based monomer, polyfunctional allyl ether-based monomer, and polyfunctional allyl ester-based monomer

Item 5. The ink composition according to item 4, in which the compound of the compound group (2-a) has a molecular weight of 100 to 300.
Item 6. The ink composition according to item 5, in which the compound of the compound group (2-a) is a compound having a (meth)acrylate moiety and an alkyl group or a cycloalkyl group having 6 to 16 carbon atoms, at least one —CH₂— in the alkyl group or the cycloalkyl group may be replaced by —O—, —CO—, —COO—, —OCO—, or —OCOO—, and at least one —(CH₂)₂— may be replaced by —CH═CH— or —C≡C—.
Item 7. The ink composition according to item 5, in which the compound of the compound group (2-a) is at least one selected from the group consisting of tetrahydrofurfuryl (meth)acrylate, alkoxylated tetrahydrofurfuryl (meth)acrylate, 2-(allyloxymethyl) methyl (meth)acrylate, 2-(2-vinyloxyethoxy) ethyl (meth)acrylate, 2-hydroxyethyl (meth)acrylate, 2-hydroxypropyl (meth)acrylate, 4-hydroxybutyl (meth)acrylate, isobornyl (meth)acrylate, lauryl (meth)acrylate, cyclohexyl (meth)acrylate, 2-phenoxyethyl (meth)acrylate, 3,3,5-trimethylcyclohexanol (meth)acrylate, isodecyl (meth)acrylate, dicyclopentenyl (meth)acrylate, adamantyl (meth)acrylate, and tridecanyl (meth)acrylate.
Item 8. The ink composition according to item 5, in which the compound of the compound group (2-a) is a compound having a (meth)acrylate moiety and an alkyl group or a cycloalkyl group having 6 to 16 carbon atoms, and at least one —(CH₂)₂— in the alkyl group or the cycloalkyl group may be replaced by —CH═CH— or —C≡C—.
Item 9. The ink composition according to item 5, in which the compound of the compound group (2-a) is at least one selected from the group consisting of isobornyl (meth)acrylate, lauryl (meth)acrylate, cyclohexyl (meth)acrylate, 3,3,5-trimethylcyclohexanol (meth)acrylate, isodecyl (meth)acrylate, dicyclopentenyl (meth)acrylate, adamantyl (meth)acrylate, and tridecanyl (meth)acrylate.
Item 10. The ink composition according to any one of items 4 to 9, in which the compound of the compound group (2-b) has a molecular weight of 200 to 1000.
Item 11. The ink composition according to item 10, in which the compound of the compound group (2-b) has 4 to 10 oxygen atoms in a molecule thereof.
Item 12. The ink composition according to item 10, in which the compound of the compound group (2-b) is at least one selected from the group consisting of dodecanediol di(meth)acrylate, polyethylene glycol di(meth)acrylate, EO-modified bisphenol A di(meth)acrylate, EO-modified bisphenol F di(meth)acrylate, tricyclodecanedimethanol di(meth)acrylate, trimethylolpropane diallyl ether, trimethylolpropane tri(meth)acrylate, trimethylolpropane EO-modified tri(meth)acrylate, EO-modified diglycerin tetra(meth)acrylate, nonanediol di(meth)acrylate, neopentyl glycol di(meth)acrylate, EO-modified trimethylolpropane tri(meth)acrylate, ditrimethylolpropane tetra(meth)acrylate, glycerol tri(meth)acrylate, diglycerin tetra(meth)acrylate, pentaerythritol tri(meth)acrylate, pentaerythritol tetra(meth)acrylate, dipentaerythritol hexa(meth)acrylate, decanediol di(meth)acrylate, isocyanuric acid EO-modified di(meth)acrylate, isocyanuric acid EO-modified tri(meth)acrylate, tris[(meth)acryloxyethyl] isocyanurate, and polybutadiene di(meth)acrylate.
Item 13. The ink composition according to item 10, in which the compound of the compound group (2-b) is at least one selected from the group consisting of dodecanediol di(meth)acrylate, tricyclodecanedimethanol di(meth)acrylate, trimethylolpropane diallyl ether, nonanediol di(meth)acrylate, neopentyl glycol di(meth)acrylate, decanediol di(meth)acrylate, and polybutadiene di(meth)acrylate.
Item 14. The ink composition according to any one of items 1 to 13, in which the monomer as the second component has Hansen solubility parameters (δD, δP, and δH) of δD: 13.0 to 18.0, δP: 2.0 to 6.0, and δH: 2.0 to 6.0.
Item 15. The ink composition according to any one of items 1 to 14, in which

relative to the solid component in the ink composition,

the first component has a content of 5.0 to 60.0% by weight,

the second component has a content of 25.0 to 94.0% by weight, and

the third component has a content of 1.0 to 15.0% by weight.

Item 16. The ink composition according to any one of items 1 to 15, containing at least one photosensitizer as a fourth component.
Item 17. The ink composition according to any one of Items 1 to 16, containing at least one surfactant as a fifth component.
Item 18. The ink composition according to any one of items 1 to 17, having a viscosity of 1 to 50 mPa·s at 25° C. and a surface tension of 15 to 35 mN/m at 25° C.
Item 19. A cured product formed using the ink composition according to any one of items 1 to 18, having a refractive index of 1.6 to 2.0 after curing.
Item 20. A cured product formed using the ink composition according to any one of items 1 to 19, having a dielectric constant of 1.5 to 4.6 after curing.
Item 21. A display element including the cured product according to item 19 or 20.
Item 22. A touch sensor device including the cured product according to item 19 or 20.
Item 23. A light extraction structure including the cured product according to item 19 or 20.
Item 24. An organic thin film device having a barrier layer, in which the barrier layer is a laminate of a layer formed of the following compound group (P-1) and a layer formed of compound group (P-2).

Compound group (P-1): at least one compound selected from the group consisting of silicon nitride, silicon nitride oxide, silicon nitride carbide, silicon nitride oxide carbide, and aluminum oxide

Compound group (P-2): a cured product manufactured using the ink composition according to any one of items 1 to 18, or the cured product according to item 19 or 20

Item 25. The organic thin film device according to item 24, which is an organic electroluminescent element.
Item 26. A method for manufacturing the organic thin film device according to item 24.

### Advantageous Effects of Invention

According to a preferable embodiment of the present invention, it is possible to provide an ink composition having a good film-forming property and good inkjet ejection stability. In a case where the composition is cured, it is possible to provide a cured product which can be used, for example, for a sealing agent for an organic thin film device such as an organic electroluminescent element, a transparent insulating film, or an overcoat, and which has a high refractive index, a high transmittance, high flexibility, and/or a low dielectric constant. For example, it is possible to improve a light extraction efficiency, which is an object of a top emission type organic electroluminescent element as a main stream in recent years.

### BRIEF DESCRIPTION OF DRAWINGS

FIG. 1 is a schematic cross-sectional view illustrating an organic electroluminescent element according to the present embodiment.

FIG. 2 is a schematic cross-sectional view illustrating an organic electroluminescent element having a laminated barrier layer (sealing structure) according to the present embodiment.

FIG. 3 is a schematic cross-sectional view illustrating an organic electroluminescent element having a laminated barrier layer (sealing structure) according to the present embodiment.

FIG. 4 is a schematic cross-sectional view illustrating an organic electroluminescent element having a single barrier layer (sealing structure) according to the present embodiment.

### DESCRIPTION OF EMBODIMENTS

### 1. Ink Composition of the Present Invention

An ink composition of the present invention is an ink composition containing: as a first component, at least one inorganic filler selected from the group consisting of zirconium oxide, titanium oxide, hafnium oxide, barium titanate, boron nitride, and cerium oxide having an average particle diameter of 1 to 30 nm; as a second component, at least one monomer selected from (meth)acrylate-based monomers; and as a third component, at least one polymerization initiator, in which the total weight concentration of the first to third components is 98 to 100% by weight relative to the total weight of the ink composition.

### 1.1 First Component: Inorganic Filler

The inorganic filler is preferably formed of, for example, oxide particles of an element belonging to Group 4 of the periodic table. By adding fine particles having a high refractive index, the refractive index of an obtained cured film can be further increased. Specific examples thereof include zirconium oxide, titanium oxide, hafnium oxide, and barium titanate. In addition thereto, boron nitride, cerium oxide, and the like are also preferable. Titanium oxide and zirconium oxide are preferable, and zirconium oxide is more preferable from a viewpoint of an effect of increasing the refractive index of an obtained cured film.

Titanium oxide has photocatalytic activity, and therefore surfaces of the particles thereof are preferably covered with silicon oxide or the like in order to be used for optical applications. Titanium oxide includes an anatase type and a rutile type depending on a crystal type, and the rutile type is preferable because of having a high refractive index and excellent light resistance.

Generally, zirconium oxide contains hafnium having chemically similar characteristics as an impurity in a form in which zirconium is replaced with hafnium. For the purpose of the present invention, purified hafnium oxide or zirconium oxide may be used, or zirconium oxide containing hafnium as an impurity or hafnium oxide containing zirconium as an impurity may be used.

Similarly, if a main component of the inorganic filler is zirconium oxide, titanium oxide, hafnium oxide, barium titanate, boron nitride, or cerium oxide, an impurity may be contained.

The inorganic filler may be a compound in which the structure is different depending on a portion. Examples thereof include a core shell type in which the structure of the center is different from that of an outer shell and a core multi shell type having a multilayer structure. A core portion may be partially exposed from a defect or a hole in a shell.

When light is incident on a composition in which an inorganic filler is dispersed in a cured product, Rayleigh scattering due to the dispersed particles occurs. By reducing this Rayleigh scattering, the incident light can pass through the composition without being scattered. For example, in a case where a composition is cured to manufacture a sealing agent or the like of an organic thin film device, it is possible to improve the light extraction efficiency as described above. In a case where a composition is cured to manufacture an optical waveguide, the amount of scattering of an optical signal propagated through the optical waveguide is small. Therefore, light propagation loss of the optical waveguide is reduced. Since the Rayleigh scattering is proportional to the cube of the particle diameter of a dispersed particle, in order to suppress scattering of the dispersed particle, a smaller primary particle diameter of the inorganic filler in the composition is more preferable.

Generally, if the primary particle diameter is about 1/10 or less of a wavelength, light scattering due to the inorganic filler in the cured film is suppressed. Therefore, the primary particle diameter is preferably 30 nm or less from a viewpoint of transparency. If the primary particle diameter is larger than 30 nm, haze of the cured film is large (whitened) due to light scattering of the inorganic filler in the cured film. Usually, the particle diameter has a distribution. Therefore, even particles having an average particle diameter of 30 nm contain a particle having a large particle diameter. The primary particle diameter is preferably 20 nm or less considering the particle diameter distribution from a viewpoint of reducing haze. An inorganic filler having a primary particle diameter of less than 1 nm has poor dispersion stability and is difficult to manufacture. From the above, the primary particle diameter of the inorganic filler of the cured product is 1 to 30 nm, preferably 1 to 20 nm, more preferably 1 to 15 nm, and still more preferably 1 to 10 nm.

The inorganic filler in the composition includes an inorganic filler in a state of primary particles in which aggregation is completely loosened and an inorganic filler in a state in which a plurality of primary particles is aggregated. Here, the primary particle diameter of the inorganic filler is the particle diameter of a non-aggregated particle, and the particle diameter of an aggregate in which primary particles are aggregated is an aggregated particle diameter. Examples of a method for measuring the primary particle diameter of the inorganic filler in the composition include a method for directly observing particles with a scanning electron microscope (SEM) or a transmission electron microscope (TEM) and a method for measuring the primary particle diameter by a dynamic light scattering method (DLS).

The “average particle diameter” here means a particle diameter at an integrated value of 50% in a particle diameter distribution determined by the above SEM, TEM, or DLS method, and is also expressed as D₅₀ or a median diameter.

The inorganic filler of the present invention may be subjected to a surface treatment. An attractive force by a van der Waals force acts between nano-sized particles existing in a liquid phase. Therefore, a smaller primary particle diameter of the inorganic filler is more preferable from a viewpoint of transparency, but a cured film may be whitened due to secondary aggregation. Therefore, it is necessary to give a repulsive force to overcome the attractive force by a van der Waals force between particles to prevent aggregation.

In order to give a repulsive force to overcome the attractive force by a van der Waals force, for example, a method using an exclusion volume effect by a molecular layer such as a polymer adsorbed on a particle surface or an amphiphilic molecule is used. An inorganic filler having a molecular layer exhibiting an exclusion volume effect is manufactured, for example, by covering a surface of an inorganic nanoparticle with a molecule having a long chain alkyl, a polyethylene glycol chain, a poly(meth)acrylate chain, a polydimethylsiloxane chain, or a long chain perfluoroalkyl using physical/chemical adsorption and/or chemical bonding. Use of a long and flexible molecule increases an exclusion volume effect. The molecule is physically/chemically adsorbed on and/or chemically bonded to a surface of the inorganic nanoparticle using a functional group such as a carboxylic acid group, a thiocarboxylic acid group, a phosphoric acid group, a phosphate group, a hydroxyl group, a thiol group, a disulfide group, a thioether group, an ether group, an amine group, an imine group, an ammonium group, an alkoxysilyl group, or an alkoxytitanium group. Some of these molecules are adsorbed by an electrostatic interaction with a bond defect (dagling bond) on a surface of the inorganic nanoparticle or an orbit of a surface atom, and some of these functional molecules form a chemical bond. The molecules having functional groups that form a chemical bond can cover the surface more firmly. In addition, some of these molecules are adsorbed on/bonded to the surface at one point, and some of these molecules are adsorbed on/bonded to the surface at many points. The molecules adsorbed on/bonded to the surface at many points can cover the surface more firmly.

In the present invention, for stabilization against aggregation of the inorganic filler, a low molecular weight or high molecular weight dispersant having a hydroxyl group, a thiol group, a carboxylic acid group, a phosphoric acid group, a phosphate group, a phosphine oxide, an amine group, or an imine group, and an alkoxysilane-based dispersant are preferably used. More specifically, examples of the low molecular weight dispersant include heptanol, hexanol, octanol, benzyl alcohol, phenol, ethanol, propanol, butanol, oleyl alcohol, dodecyl alcohol, octadecanol, triethylene glycol, octanethiol, dodecanethiol, octadodecanethiol, monomethyl ether octanoic acid, acetic acid, propionic acid, 2-[2-(2-methoxyethoxy) ethoxy] acetic acid, oleic acid, benzoic acid, triphenylphosphine, tributylphosphine, trioctylphosphine, trioctylphosphine oxide, hexylamine, heptylamine, octylamine, decylamine, dodecylamine, octadecylamine, tripropylamine, tributylamine, pentylamine, trihexylamine, triheptylamine, trioctylamine, trinonylamine, tridecylamine, tridodecylamine, tritetradecylamine, tripentadecylamine, tricetylamine, and oleylamine. Examples of the high molecular weight dispersant include a polysaccharide derivative, an acrylic copolymer, a butyral resin, a vinyl acetate copolymer, a hydroxyl group-containing carboxylate, a salt of a high molecular weight polycarboxylic acid, an alkylpolyamine-based compound, and a polyhydric alcohol ester-based compound. Examples of the alkoxysilane-based dispersant include n-propyltrimethoxysilane, n-propyltriethoxysilane, n-octyltrimethoxysilane, n-octyltriethoxysilane, phenyltrimethoxysilane, 2-[methoxy (polyethyleneoxy) propyl]-trimethoxysilane, methoxytri(ethyleneoxy) propyltrimethoxysilane, 3-aminopropyltrimethoxysilane, 3-mercaptopropyltrimethoxysilane, 3-(methacryloyloxy) propyltrimethoxysilane, 3-isocyanatopropyltriethoxysilane, 3-isocyanatopropyltrimethoxysilane, and glycidoxypropyltrimethoxysilane.

In the present invention, as a compound used for the inorganic filler, 2-[2-(2-methoxyethoxy) ethoxy] acetic acid, 2-[methoxy (polyethyleneoxy) propyl]-trimethoxysilane, and methoxytri(ethyleneoxy) propyltrimethoxysilane, which are adsorbed at one point and each have a (poly) ethylene glycol chain, and an acrylic copolymer and a hydroxyl group-containing carboxylate which are high molecular weight dispersants each having a hydroxyl group and/or a carboxylic acid group are preferable.

Meanwhile, a dispersant used for covering the inorganic filler may have good or poor compatibility with another component. Therefore, attention needs to be paid to selection of a (meth)acrylate-based monomer as a second component and an additives as the other component. For example, in a case where an alkoxysilane-based dispersant having a (poly)ethylene glycol chain or a high molecular weight dispersant having a hydroxyl group and/or a carboxylic acid group is used, the dispersants have a polarity. Therefore, if a (meth)acrylate-based monomer having strong hydrophobicity or an additive having a reverse charge is used, characteristics may be deteriorated. In a case where, for example, a commercially available inorganic filler previously covered with a dispersant is used, it is only required to specify a dispersant used and to select a suitable (meth)acrylate-based monomer.

The refractive index (refractive index nD not as nanoparticles but as a bulk material) of the inorganic filler is 1.6 to 3.5, preferably 1.8 to 3.0, and more preferably 2.0 to 2.8.

The inorganic filler may be powdery or may be dispersed in a reactive monomer. Examples of a dispersion medium include a (meth)acrylate monomer, a (meth)acrylate oligomer, an epoxy monomer, an oxetane monomer, an acid anhydride, and an amine compound.

Examples of a powdery commercially available product that can be used as the inorganic filler include TECNAPOW-CEO2, TECNAPOW-TIO2, and TECNAPOW-ZRO2 manufactured by TECNAN S.L. Examples of a commercially available monomer dispersion that can be used as the inorganic filler include zirconia/acrylate monomer dispersion #1976 and MHI fillers #FM-089M and B943M manufactured by Mikuni Color Ltd., and The Clear Solution PCPN-80-BMT manufactured by Pixelligent Technologies, LLC.

In a case where the content of the inorganic filler is 5.0% by weight or more, 8% by weight or more, or 10% by weight or more relative to the solid component in the ink composition, a cured product having a refractive index of 1.6 or more is easily obtained from a viewpoint of the refractive index of the cured product. In a case where the content of the inorganic filler is 15% by weight or more or 20% by weight or more, a cured product having a refractive index of 1.65 or more is easily obtained. In a case where the content of the inorganic filler is 35% by weight or more, a cured product having a refractive index of 1.7 or more is easily obtained. In a case where the content of the inorganic filler is 35% by weight or less relative to a solid component in the ink composition, a cured product having a dielectric constant of 4 or less is easily obtained from a viewpoint of the dielectric constant of the cured product. In a case where the content of the inorganic filler is 60% by weight or less, a viscosity of 100 mPa·s or less which is an upper limit value of an inkjet printable viscosity is obtained from a viewpoint of the viscosity of the ink composition. In a case where the content of the inorganic filler is 50% by weight or less, a viscosity of 30 mPa·s or less which is an upper limit value of a preferable viscosity for inkjet printing is obtained. In a case where the content of the inorganic filler is 20% by weight or more, a viscosity of 5 mPa·s or more which is a lower limit value of a preferable viscosity for inkjet printing is obtained.

The content of the inorganic filler is preferably 5.0 to 60.0% by weight relative to the solid component in the ink composition. More precisely, the content of the inorganic filler is determined on the basis of the refractive index of an inorganic material layer of a sealing film having a laminated structure of organic material-inorganic material by a relationship with other components forming the inorganic material layer. In a case where the refractive index of the inorganic material layer is 1.65, the content of the inorganic filler is more preferably 8.0 to 50.0% by weight, 10.0 to 50.0% by weight, 15.0 to 50.0% by weight, or 20.0 to 50.0% by weight relative to the solid component in the ink composition. In a case where the refractive index of the inorganic material layer is 1.70, the content of the inorganic filler is more preferably 10.0 to 50.0% by weight, 15.0 to 50.0% by weight, 20.0 to 50.0% by weight, or 35.0 to 50.0% by weight relative to the solid component in the ink composition.

A larger content of the inorganic filler is more preferable from a viewpoint of high refractive index. A smaller content of the inorganic filler is more preferable from a viewpoint of low dielectric constant. Even at the same concentration, in a case where the inorganic filler is surrounded by a compound having a high refractive index under an influence of a dispersant or a dispersion medium (monomer) around the inorganic filler, a high refractive index is easily obtained, and in a case where the inorganic filler is surrounded by a compound having a low dielectric constant under an influence of a dispersant or a dispersion medium (monomer) around the inorganic filler, a low dielectric constant is easily obtained. Furthermore, even if the inorganic filler is surrounded by the same compound, in a case where the density is high under an influence of the surrounding density, a high refractive index is easily obtained, and in a case where the density is low under an influence of the surrounding density, a low dielectric constant is easily obtained.

The structure of the inorganic filler also has an influence on the refractive index and the dielectric constant. Generally, in a case where the density of the inorganic filler is high, a high refractive index is easily obtained, and in a case where the density is low, a low dielectric constant is easily obtained. In a case where the density of the inorganic filler is high, the inorganic filler is sintered at a high temperature and has few structural defects. Meanwhile, in a case where the density of the inorganic filler is low, the inorganic filler has many structural defects, is closer to amorphous, and may be porous or hollow. The shape (sphere, cube, flat plate, or star shape) of the inorganic filler also has an influence on the refractive index and the dielectric constant.

### 1.2 Second Component: (meth)acrylate-Based Monomer

The (meth)acrylate-based monomer used as the second component in the present invention means an acrylate-based monomer or a methacrylate-based monomer, is a compound having an acrylic group or a methacrylic group, and is a compound having at least one selected from the group consisting of an alkyl group, an alkenyl group, an ether group, and an aryl group.

In the present invention, the “(meth)acrylate moiety” in the (meth)acrylate-based monomer indicates the inside of the broken line frame in formula A. Here, in formula A, X, Y, and Z indicate positions to which a substituent such as a hydrogen atom or an alkyl group can be connected. In a case where Y represents a methyl group, formula A represents a methacrylate-based monomer. In a case where Y represents a group other than a methyl group (for example, a hydrogen atom or an alkyl-based substituent having 2 or more carbon atoms), formula A represents an acrylate-based monomer. For example, in methyl 2-(allyloxymethyl) acrylate illustrated in formula B, X represents a methyl group, Y represents an allyloxymethyl group, and Z represents a hydrogen atom.

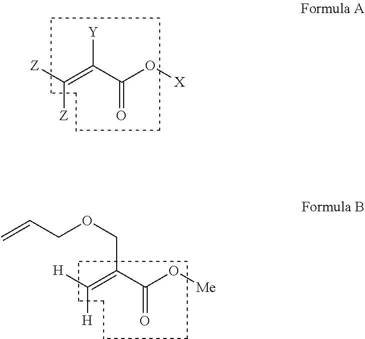

The (meth)acrylate-based monomer can be classified into a compound group (2-a): a monofunctional (meth)acrylate-based monomer and a compound group (2-b): a polyfunctional (meth)acrylate-based monomer, a polyfunctional allyl ether-based monomer, and a polyfunctional allyl ester-based monomer for each function.

The monofunctional (meth)acrylate-based monomer (compound group (2-a)) is a monofunctional (meth)acrylate-based monomer having high dilutability. In a case where the inorganic filler as the first component is covered with a dispersant and has a high concentration, the adjacent dispersant of the inorganic filler entangles with the monofunctional (meth)acrylate-based monomer, resulting in high viscosity. For that reason, it is necessary to adjust the viscosity to a low viscosity suitable for a printing method. Conventionally, the viscosity can be largely reduced by adding a solvent. However, in the present invention, the amount of a solvent is kept extremely low, or preferably no solvent is used. Therefore, it is preferable to select a compound that is hardly volatilized or a compound that can largely reduce a volatile component by curing.

That is, as the characteristics of the monofunctional (meth)acrylate-based monomer (compound group (2-a)), desirably, the viscosity is low, the entanglement with a dispersant and an interaction therewith are small, the dilutability is high, the volatility is low at normal temperature and normal pressure, and the curability is high.

The smaller the volume occupied by a compound having a low refractive index in the cured product is, the higher the refractive index to be obtained is from a viewpoint of the refractive index of the cured product. Therefore, the second component is preferably a smaller molecule.

From the above, the molecular weight of the monofunctional (meth)acrylate-based monomer (compound group (2-a)) used as the second component of the present invention is preferably 100 to 300, and more preferably 150 to 250. The viscosity at 25° C. is preferably 1 to 25 mPa·s, and more preferably 1 to 20 mPa·s.

The monofunctional (meth)acrylate-based monomer (compound group (2-a)) used as the second component of the present invention is preferably a compound having a (meth)acrylate moiety and an alkyl group or a cycloalkyl group having 6 to 16 carbon atoms. At least one —CH₂— in the alkyl group or the cycloalkyl group may be replaced by —O—, —CO—, —COO—, —OCO—, or —OCOO—, and at least one —(CH₂)₂— may be replaced by —CH═CH— or —C≡C—.

A compound to be used as the second component can be selected based on a relationship between a structure and a dielectric constant clarified by Clausius-Mossotti (D. W. VanKrevelen, “Properties of Polymer, 2nd Ed.”, pp. 321-329, Scientific Publishing Company (1991) and I. Ogura, “High Dielectric Constant Material and Their Low Dielectric Constant Applications, Low Dielectric Constant Epoxy Resin”, Academic Press (1999)) from a viewpoint of the dielectric constant of the cured product.

$$ɛ = \frac{1 + 2 ( \frac{Σϕ}{Σ v} )}{1 - ( \frac{\sum ϕ}{Σ v} )} \qquad Formula 1$$

The above formula 1 is an estimation formula of the dielectric constant by Clausius-Mossotti, illustrating a relationship between a molecular structure and the dielectric constant of a cured product to be formed. In this estimation formula, φ represents a molar polarizability of a functional group, and ν represents a molar volume of a functional group. That is, a smaller molar polarizability/molar volume brings about a lower dielectric constant. With respect to the molar polarizability/molar volume of a methylene group (—CH₂—) and a methine group (—CH—) which are main chains formed by polymerization and crosslinking of the second component, a fluoro group (—F) and a methyl group (—CH₃) have a low molar polarizability/molar volume, which is advantageous for reducing a dielectric constant. Meanwhile, a phenylene group (-Ph-), an ester (—O(═O)O—), a ketone group (—C(═O)—), an ether group (—O—), and a hydroxyl group (—OH) have a large molar polarizability/molar volume, which is disadvantageous for reducing a dielectric constant. That is, a compound having an alkyl group having a large molecular weight and many branches and many fluoro groups in a molecule thereof and having a small number of polar groups is advantageous for a low dielectric constant. Although this estimation formula does not strictly coincide with actual measurement values, a rough trend coincides with the actual measurement.

Preferably, the second component does not contain many oxygen atoms in a molecule thereof or does not contain any oxygen atom except for in the (meth)acrylate moiety from a viewpoint of the dielectric constant of the cured product. For example, the monofunctional (meth)acrylate-based monomer (compound group (2-a)) used as the second component of the present invention is preferably a compound having a (meth)acrylate moiety and an alkyl group or a cycloalkyl group having 6 to 16 carbon atoms, in which at least one —(CH₂)₂— in the alkyl group or the cycloalkyl group may be replaced by —CH═CH— or —C≡C—.

Specific examples of the monofunctional (meth)acrylate-based monomer (compound group (2-a)) include: an ester of an alkyl alcohol having 1 to 18 carbon atoms and (meth)acrylic acid, such as methyl (meth)acrylate, ethyl (meth)acrylate, isopropyl (meth)acrylate, butyl (meth)acrylate, isobutyl (meth)acrylate, t-butyl (meth)acrylate, octyl (meth)acrylate, isodecyl (meth)acrylate, lauryl (meth)acrylate, stearyl (meth)acrylate, cyclohexyl (meth)acrylate, 4-t-butylcyclohexanol (meta)acrylate, dicyclopentenyloxyethyl (meth)acrylate, dicyclopentenyl (meth)acrylate, 3,3,5-trimethylcyclohexanol (meth)acrylate, adamantyl (meth)acrylate, tridecanyl (meth)acrylate, or isobornyl (meth)acrylate; an aromatic ring-containing (meth)acrylate-based monomer such as phenyl (meth)acrylate, benzyl (meth)acrylate, or 2-phenoxyethyl (meth)acrylate; a cyclic ether-containing (meth)acrylate-based monomer such as tetrahydrofurfuryl (meth)acrylate, alkoxylated tetrahydrofurfuryl (meth)acrylate, 5-tetrahydrofurfuryloxycarbonylpentyl (meth)acrylate, or cyclic trimethylolpropane formal (meth)acrylate; an ethylene glycol skeleton-containing (meth)acrylate-based monomer such as diethylene glycol methyl ether (meth)acrylate, diethylene glycol ethyl ether (meth)acrylate, triethylene glycol methyl ether (meth)acrylate, triethylene glycol ethyl ether (meth)acrylate, tetraethylene glycol methyl ether (meth)acrylate, or tetraethylene glycol ethyl ether (meth)acrylate; a (meth)acrylate of an ethylene oxide adduct of lauryl alcohol; methyl 2-(allyloxymethyl) (meth)acrylate; 2-(2-vinyloxyethoxy) ethyl (meth)acrylate; 2-hydroxyethyl (meth)acrylate; 2-hydroxypropyl (meth)acrylate; 4-hydroxybutyl (meth)acrylate; 1,4-cyclohexane dimethanol mono(meth)acrylate; (meth)acrylic acid; ω-carboxypolycaprolactone mono(meth)acrylate; glycidyl (meth)acrylate; 3,4-epoxycyclohexyl (meth)acrylate; methylglycidyl (meth)acrylate; 3-methyl-3-(meth)acryloxymethyl oxetane; 3-ethyl-3-(meth)acryloxymethyl oxetane; 3-methyl-3-(meth)acryloxyethyl oxetane; 3-ethyl-3-(meth)acryloxyethyl oxetane; p-vinylphenyl-3-ethyloxetan-3-ylmethyl ether; 2-phenyl-3-(meth)acryloxymethyloxetane; 2-trifluoromethyl-3-(meth)acryloxymethyloxetane; 4-trifluoromethyl-2-(meth)acryloxymethyloxetane; (3-ethyl-3-oxetanyl) methyl (meth)acrylate; (meth)acrylamide, glycerol mono(meth)acrylate; ω-carboxypolycaprolactone mono(meth)acrylate; mono[2-(meth)acryloyloxyethyl] succinate; mono[2-(meth)aryloyloxyethyl maleate; cyclohexene-3,4-mono[2-(meth)acryloyloxyethyl] dicarboxylate; and N-acryloyl morpholine.

More specifically, tetrahydrofurfuryl (meth)acrylate, alkoxylated tetrahydrofurfuryl (meth)acrylate, 2-(allyloxymethyl) methyl (meth)acrylate, 2-(2-vinyloxyethoxy) ethyl (meth)acrylate, isobornyl (meth)acrylate, lauryl (meth)acrylate, cyclohexyl (meth)acrylate, 2-phenoxyethyl (meth)acrylate, 3,3,5-trimethylcyclohexanol (meth)acrylate, isodecyl (meth)acrylate, dicyclopentenyl (meth)acrylate, adamantyl (meth)acrylate, and tridecanyl (meth)acrylate are preferable, and tetrahydrofurfuryl (meth)acrylate, 2-(allyloxymethyl) methyl (meth)acrylate, and 2-(2-vinyloxyethoxy) ethyl (meth)acrylate are more preferable from a viewpoint of low viscosity, high dilutability, low volatility, or high curability.

Specifically, isobornyl (meth)acrylate, lauryl (meth)acrylate, cyclohexyl (meth)acrylate, 3,3,5-trimethylcyclohexanol (meth)acrylate, isodecyl (meth)acrylate, dicyclopentenyl (meth)acrylate, adamantyl (meth)acrylate, and tridecanyl (meth)acrylate are preferable from a viewpoint of the dielectric constant of the cured product.

The polyfunctional (meth)acrylate-based monomer, the polyfunctional allyl ether-based monomer, and the polyfunctional allyl ester-based monomer (compound group (2-b)) used as the second component in the present invention are highly curable crosslinking agents. Since the above-described monofunctional acrylate-based monomer (compound group (2-a)) generates only a linear polymer, a cured film tends to be soft and brittle. Therefore, in order to increase the mechanical strength of the cured film, a crosslinking agent is preferably added. Generally, a compound having a larger number of (meth)acrylic groups tends to exhibit a faster curing property to obtain a harder film, but may cause large curing shrinkage.

The smaller the volume occupied by a compound having a low refractive index in the cured product is, the higher the refractive index to be obtained is from a viewpoint of the refractive index of the cured product. Therefore, the second component is preferably a smaller molecule.

From the above, the molecular weight of each of the polyfunctional (meth)acrylate-based monomer, the polyfunctional allyl ether-based monomer, and the polyfunctional allyl ester-based monomer (compound group (2-b)) used as the second component of the present invention is preferably 200 to 1000. The molecular weight is more preferably 200 to 600 from a viewpoint of the refractive index.

Each of the polyfunctional (meth)acrylate-based monomer, the polyfunctional allyl ether-based monomer, and the polyfunctional allyl ester-based monomer (compound group (2-b)) used as the second component of the present invention has 4 to 10 oxygen atoms in a molecule thereof.

The relationship between a structure and a dielectric constant clarified by Clausius-Mossotti can also be applied to the polyfunctional (meth)acrylate-based monomer used as the second component of the present invention. That is, preferably, the second component does not contain many oxygen atoms in a molecule thereof, does not contain any oxygen atom except for in the (meth)acrylate moiety, or limits the number of the (meth)acrylate moieties from a viewpoint of the dielectric constant of the cured product. For example, each of the polyfunctional (meth)acrylate-based monomer, the polyfunctional allyl ether-based monomer, and the polyfunctional allyl ester-based monomer (compound group (2-b)) used as the second component of the present invention is preferably a compound in which the number of (meth)acrylates contained in a molecule thereof is smaller, and more preferably a compound having two (meth)acrylates in a molecule thereof.

Specific examples of a bifunctional (meth)acrylate-based monomer include: a diester of an alkyl dialcohol having 1 to 12 carbon atoms, such as 1,4-butanediol dimethacrylate, 1,6-hexanediol di(meth)acrylate, 1,9-nonanediol di(meth)acrylate, 1,4-cyclohexane dimethanol di(meth)acrylate, tricyclodecane dimethanol di(meth)acrylate, neopentyl glycol di(meth)acrylate, decanediol di(meth)acrylate, or 1,12-dodecanediol di(meth)acrylate; EO -modified bisphenol F di(meth)acrylate; EO-modified bisphenol F di(meth)acrylate; PO-modified bisphenol F di(meth)acrylate; EO-modified bisphenol A di(meth)acrylate; PO-modified bisphenol A di(meth)acrylate; isocyanuric acid EO-modified di(meth)acrylate; isocyanuric acid EO-modified tri(meth)acrylate; polyethylene glycol di(meth)acrylate; polypropylene glycol di(meth)acrylate; pentaerythritol di(meth)acrylate; pentaerythritol di(meth)acrylate monostearate; 2-n-butyl-2-ethyl-1,3-propanediol di(meth)acrylate; trimethylolpropane di(meth)acrylate; dipentaerythritol di(meth)acrylate; and polybutadiene di(meth)acrylate.

Specific examples of a trifunctional or higher functional polyfunctional (meth)acrylate-based monomer include trimethylolpropane tri(meth)acrylate, EO-modified trimethylolpropane tri(meth)acrylate, PO-modified trimethylolpropane tri(meth)acrylate, epichlorohydrin-modified trimethylolpropane tri(meth)acrylate, ditrimethylolpropane tetra(meth)acrylate, glycerol tri(meth)acrylate, epichlorohydrin-modified glycerol tri(meth)acrylate, diglycerin tetra(meth)acrylate, EO-modified diglycerin tetra(meth)acrylate, pentaerythritol tri(meth)acrylate, pentaerythritol tetra(meth)acrylate, dipentaerythritol penta(meth)acrylate, alkyl-modified dipentaerythritol penta(meth)acrylate, alkyl-modified dipentaerythritol tetra (meth)acrylate, alkyl-modified dipentaerythritol tri(meth)acrylate, dipentaerythritol hexa(meth)acrylate, caprolactone-modified dipentaerythritol hexa(meth)acrylate, EO-modified phosphoric acid tri(meth)acrylate, tris[(meth)acryloxyethyl] isocyanurate, and caprolactone-modified tris[(meth)acryloxyethyl] isocyanurate.

Specifically, dodecanediol di(meth)acrylate, tricyclodecanedimethanol di(meth)acrylate, trimethylolpropane diallyl ether, nonanediol di(meth)acrylate, neopentyl glycol di(meth)acrylate, decanediol di(meth)acrylate, polybutadiene di(meth)acrylate, and the like are preferable from a viewpoint of the dielectric constant of the cured product.

The content of the second component is preferably 25.0 to 94.0% by weight relative to the solid component in the ink composition. Within such a concentration range, a cured film formed from the ink composition of the present invention has good refractive index, dielectric constant, and flatness. The content is more preferably 30 to 80% by weight, 30 to 84% by weight, or 30 to 94% by weight, still more preferably 40 to 80% by weight, 40 to 84% by weight, or 40 to 94% by weight, and particularly preferably 50 to 80% by weight, 50 to 84% by weight, or 50 to 94% by weight. from viewpoints of dispersion stability of the first component in the ink composition and refractive index and dielectric constant of the cured product.

The monomer as the second component preferably has Hansen solubility parameters (δD, δP, and δH) of δD: 13.0 to 18.0, δP: 2.0 to 6.0, and δH: 2.0 to 6.0. In a case where the ink composition contains a plurality of monomers, the Hansen solubility parameters of the ink composition can be calculated from solubility parameters of these monomers mixed and a mixing ratio thereof. If the solubility parameters of the monomer as the second component are within the above ranges, a composition having good dispersion stability can be obtained.

The Hansen solubility parameters are obtained by dividing a Hildebrand solubility parameter (δ) into three components of a dispersion term (δD), a polar term (δP), and a hydrogen bond term (δH) assuming that three interactions of a London dispersing force, a hydrogen bonding force, and a dipolar force act between a solute in a solvent and the solvent. The dispersion term (δD), the polar term (δP), and the hydrogen bond term (δH) indicate an effect by a dispersion force, an effect by a dipolar force, and an effect by a hydrogen bond, respectively, and the unit thereof is (MPa)^{1/2}. In a three-dimensional space with the dispersion term (δD), the polar term (δP), and the hydrogen bond term (δH) as axes, as the coordinates of compounds are closer to each other, solution occurs more easily (written by Charles M. Hansen, Hansen Solubility Parameters: A Users Handbook).

In the present invention, the Hansen solubility parameters were used to evaluate dispersibility and aggregation property of the first component with respect to the second component. Better dispersibility can be obtained as the Hansen solubility parameters of the first component are closer to the Hansen solubility parameters of the (meth)acrylate-based monomer as the second component. The Hansen solubility parameters of the first component can be measured by observing dispersibility of the first component in various solvents. The Hansen solubility parameters of the second component can be estimated from a chemical structure thereof by using computer software (Hansen Solubility Parameters in Practice (HSPiP)).

### 1.3 Third Component: Polymerization Initiator

The polymerization initiator is used for curing the above-described (meth)acrylate-based monomer. For example, a photo radical generator is preferably used.

The photo radical generator is not particularly limited as long as generating a radical or an acid by irradiation with ultraviolet light or visible light, but is preferably an acylphosphine oxide-based initiator, an oxyphenylacetic acid ester-based initiator, a benzoyl formic acid-based initiator, or a hydroxyphenyl ketone-based initiator. Among these compounds, a hydroxyphenyl ketone-based initiator is particularly preferable from viewpoints of photocurability of the ink composition, light transmittance of a resulting cured film, and the like.

Specific examples of the photo radical generator include benzophenone, Michler's ketone, 4,4′-bis(diethylamino) benzophenone, xanthone, thioxanthone, isopropylxanthone, 2,4-diethylthioxanthone, 2-ethylanthraquinone, acetophenone, 2-hydroxy-2-methyl-4′-isopropyl propiophenone, isopropyl benzoin ether, isobutyl benzoin ether, 2,2-diethoxyacetophenone, 2,2-dimethoxy-2-phenylacetophenone, camphorquinone, benzanthrone, 4-dimethylamino ethyl benzoate, isoamyl 4-dimethylaminobenzoate, 4,4′-di(t-butylperoxycarbonyl) benzophenone, 3,4,4′-tri(t-butylperoxycarbonyl) benzophenone, 3,3′,4,4′-tetra(t-butylperoxycarbonyl) benzophenone, 3,3′,4,4′-tetra(t-hexylperoxycarbonyl) benzophenone, 3,3′-di(methoxycarbonyl)-4,4′-di(t-butylperoxycarbonyl) benzophenone, 3,4′-di(methoxycarbonyl)-4,3′-di(t-butylperoxycarbonyl) benzophenone, 4,4′-di(methoxycarbonyl)-3,3′-di(t-butylperoxycarbonyl) benzophenone, 2-(4′-methoxystyryl)-4,6-bis(trichloromethyl)-s-triazine, 2-(3′,4′-dimethoxystyryl)-4,6-bis(trichloromethyl)-s-triazine, 2-(2′,4′-dimethoxystyryl)-4,6-bis(trichloromethyl)-s-triazine, 2-(2′-methoxystyryl)-4,6-bis(trichloromethyl)-s-triazine, 2-(4′-pentyloxystyryl)-4,6-bis(trichloromethyl)-s-triazine, 4-[p-N,N-di(ethoxycarbonylmethyl)]-2,6-di(trichloromethyl)-s-triazine, 1,3-bis(trichloromethyl)-5-(2′-chlorophenyl)-s-triazine, 1,3-bis(trichloromethyl)-5-(4′-methoxyphenyl)-s-triazine, 2-(p-dimethylaminostyryl) benzoxazole, 2-(p-dimethylaminostyryl) benzthiazole, 2-mercaptobenzothiazole, 3,3′-carbonylbis(7-diethylaminocoumarin), 2-(o-chlorophenyl)-4,4′,5,5′-tetraphenyl-1,2′-biimidazole, 2,2′-bis(2-chlorophenyl)-4,4′,5,5′-tetrakis(4-ethoxycarbonylphenyl)-1,2′-biimidazole, 2,2′-bis(2,4-dichlorophenyl)-4,4′,5,5′-tetraphenyl-1,2′-biimidazole, 2,2′-bis(2,4-dibromophenyl)-4,4′,5,5′-tetraphenyl-1,2′-biimidazole, 2,2′-bis(2,4,6-trichlorophenyl)-4,4′,5,5′-tetraphenyl-1,2′-biimidazole, 3-(2-methyl-2-dimethylamino propionyl) carbazole, 3,6-bis(2-methyl-2-morpholinopropionyl)-9-n-dodecylcarbazole, bis(η5-2,4-cyclopentadien-1-yl)-bis(2,6-difluoro-3-(1H-pyrrol-1-yl)-phenyl) titanium, 1-hydroxycyclohexyl phenyl ketone, 2-hydroxy-2-methyl-1-phenyl-1-propanone, 1-[4-(2-hydroxyethoxy)-phenyl]-2-hydroxy-2-methyl-1-propanone, 2-hydroxy-1-{4-[4-(2-hydroxy-2-methyl-propionyl)-benzyl] phenyl}-2-methyl-1-propanone, 2-methyl-1-[4-(methylthio)phenyl]-2-morpholino-1-propanone, 2-(dimethylamino)-1-(4-morpholinophenyl)-2-benzyl-1-butanone, 2-(dimethylamino)-2-[(4-methyphenyl)methy]-1-[4-(4-morpholinyl)phenyl]-1-butanone, oxy-phenyl-acetic acid 2-[2-oxo-2-phenyl-acetoxy-ethoxy]-ethyl ester, oxy-phenyl-acetic acid 2-[2-hydroxy-ethoxy]-ethyl ester, methyl benzoylformate, bis(2,4,6-trimethylbenzoyl) phenylphosphine oxide, 2,4,6-trimethylbenzoyl diphenylphosphine oxide, 2,4,6-trimethylbenzoyl diphenylphosphinic acid ester, 1-[4-(phenylthio) phenyl]-1,2-octanedione 2-(O-benzoyloxime)], and 1-[9-ethyl-6-(2-methylbenzoyl)-9H-carbazol-3-yl]-ethanone-1-(O-acetyloxime).

Among these compounds, 1-hydroxycyclohexyl phenyl ketone, 2-hydroxy-2-methyl-1-phenyl-1-propanone, 1-[4-(2-hydroxyethoxy)-phenyl]-2-hydroxy-2-methyl-1-propanone, 2-hydroxy-1-{4-[4-(2-hydroxy-2-methyl-propionyl)-benzyl] phenyl}-2-methyl-1-propanone, 2,2-dimethoxy-2-phenylacetophenone, oxy-phenyl-acetic acid 2-[2-oxo-2-phenyl-acetoxy-ethoxy]-ethyl ester, oxy-phenyl-acetic acid 2-[2-hydroxy-ethoxy]-ethyl ester, methyl benzoylformate, bis(2,4,6-trimethylbenzoyl) phenylphosphine oxide, 2,4,6-trimethylbenzoyl diphenylphosphine oxide, 2,4,6-trimethylbenzoyl diphenylphosphinic acid ester, and the like are preferable.

As a commercially available photo radical generator, Irgacure 184, Irgacure 651, Irgacure 127, Irgacure 907, Irgacure 1173, Irgacure 500, Irgacure 2959, Irgacure 754, Irgacure MBF, Irgacure TPO, Irgacure OXE01, Irgacure OXE02 (manufactured by BASF), and the like are preferable.

Among these compounds, use of Irgacure 1173, Irgacure 184, or Irgacure 907 is more preferable because of high reactivity and high curability of the (meth)acrylate-based monomer.

The polymerization initiator used in the composition of the present invention may be one compound or a mixture of two or more compounds. If the content of the polymerization initiator is small, a high molecular weight polymer is obtained, and therefore the curability is high in the cured product. However, deactivation of active species occurs due to oxygen, moisture, or the like on a surface of the cured product, and therefore the curability of the surface is lowered. Meanwhile, if the content of the polymerization initiator is large, a polymer does not have a high molecular weight, and therefore the curability in the cured product is low. However, more active species are generated on a surface of the cured product, and therefore the surface curability is high. The content of the polymerization initiator is preferably 1.0 to 15.0% by weight relative to a solid component in the ink composition. The content is more preferably 1 to 10% by weight, and still more preferably 1 to 5% by weight from viewpoints of curability, yellowing of the cured product, and scattering of an initiator decomposition product.

As the photo radical generator, a high molecular weight photo radical polymer having a high molecular weight is preferable. After radical polymerization is started by irradiating an ordinary photo radical generator with light, the residue may become outgas to deteriorate an element. However, it has been found that generation of the outgas can be suppressed by using the high molecular weight photo radical polymer. Examples of a commercially available product of the high molecular weight photo radical polymer include KIP-150 and KIP EM (manufactured by Lamberti S.p.A.).

### 1.4 Fourth Component: Photosensitizer

In the ink composition of the present invention, a photosensitizer can be added in order to accelerate decomposition of the polymerization initiator by irradiation with an active energy ray. The photosensitizer is preferably used in an amount of 0.1 to 10% by weight relative to the total weight of the polymerization initiator.

As the photosensitizer, it is only required to use a compound corresponding to the wavelength of an active energy ray that causes the polymerization initiator used in the ink composition to generate an initiating species. However, considering that the photosensitizer is used for a curing reaction of a general ink composition, preferable examples of the photosensitizer include those having an absorption wavelength in a range of 350 nm to 450 nm. Specific examples thereof include: a polycyclic aromatic compound such as anthracene, pyrene, perylene, or triphenylene; a thioxanthone such as isopropyl thioxanthone; fluorescein, eosin, erythrosin, rhodamine B, and a rose bengal xanthene; a cyanine such as thiacarbocyanine or oxacarbocyanine; a merocyanine such as merocyanine or carbomerocyanine; thionine, methylene blue, and a toluidine blue thiazine; an acridine such as acridine orange, chloroflavin, or acriflavine; an anthraquinone such as anthraquinone, a squarylium such as squarylium, and a coumarin such as 7-diethylamino-4-methylcoumarin. A polycyclic aromatic compound and a thioxanthone are preferable.

### 1.5 Fifth Component: Surfactant

A surfactant can be added to the ink composition of the present invention. By inclusion of the surfactant in the composition, it is possible to obtain a composition having wettability to a base substrate, a leveling property, and applicability improved. The surfactant is preferably used in an amount of 0.01 to 1% by weight relative to the total weight of the composition. The surfactant may be used singly or in combination of two or more kinds thereof.

Examples of the surfactant include, from a viewpoint of improving applicability of a composition or the like, Polyflow No. 45, Polyflow KL-245, Polyflow No. 75, Polyflow No. 90, Polyflow No. 95 (all of which are trade names, manufactured by Kyoeisha Chemical Co., Ltd.), Disperbyk 161, Disperbyk 162, Disperbyk 163, Disperbyk 164, Disperbyk 166, Disperbyk 170, Disperbyk 180, Disperbyk 181, Disperbyk 182, BYK 300, BYK 306, BYK 310, BYK 320, BYK 330, BYK 335, BYK 341, BYK 344, BYK 346, BYK 354, BYK358, BYK361 (all of which are trade names, manufactured by BYK Japan KK), KP-341, KP-358, KP-368, KF-96-50CS, KF-50-100CS (all of which are trade names, manufactured by Shin-Etsu Chemical Co., Ltd.), Surflon SC-101, Surflon KH-40 (both of which are trade names, manufactured by Seimi Chemical Co., Ltd.), Futargent 222F, Futargent 250, Futargent 251, DFX-18, FTX-218 (all of which are trade names, manufactured by Neos Co., Ltd.), EFTOP EF-351, EFTOP EF-352, EFTOP EF-601, EFTOP EF-801, EFTOP EF-802 (all of which are trade names, manufactured by Mitsubishi Materials Corporation), Megaface F-171, Megaface F-177, Megaface F-475, Megaface F-477, Megaface R-08, Megaface R-30 (all of which are trade names, manufactured by DIC Corporation), fluoroalkyl benzene sulfonate, fluoroalkyl carboxylate, fluoroalkyl polyoxyethylene ether, fluoroalkyl ammonium iodide, fluoroalkyl betaine, fluoroalkyl sulfonate, diglycerin tetrakis(fluoroalkyl polyoxyethylene ether), a fluoroalkyl trimethyl ammonium salt, fluoroalkyl aminosulfonate, polyoxyethylene nonyl phenyl ether, polyoxyethylene octyl phenyl ether, polyoxyethylene alkyl ether, polyoxyethylene lauryl ether, polyoxyethylene oleyl ether, polyoxyethylene tridecyl ether, polyoxyethylene cetyl ether, polyoxyethylene stearyl ether, polyoxyethylene laurate, polyoxyethylene oleate, polyoxyethylene stearate, polyoxyethylene lauryl amine, sorbitan laurate, sorbitan palmitate, sorbitan stearate, sorbitan oleate, sorbitan fatty acid ester, polyoxyethylene sorbitan laurate, polyoxyethylene sorbitan palmitate, polyoxyethylene sorbitan stearate, polyoxyethylene sorbitan oleate, polyoxyethylene naphthyl ether, alkylbenzene sulfonate, and alkyl diphenyl ether disulfonate.

Furthermore, a surfactant having one photoreactive functional group is preferable from a viewpoint of less volatility. The photoreactive functional group is preferably any one of (meth)acryloyl, epoxy, and oxetanyl because of higher photocurability. Specific examples of the surfactant having (meth)acryl as a photocurable functional group include RS-72K (trade name; manufactured by DIC Corporation), BYK UV 3500, BYK UV 3510, BYK UV 3570 (all of which are trade names, manufactured by BYK Japan KK), TEGO RAD 2220N, TEGO RAD 2250, TEGO RAD 3500, and TEGO RAD 3570 (all of which are trade names, manufactured by DEGUSSA AG). Examples of the surfactant having epoxy as a photocurable functional group include RS-211K (trade name) manufactured by DIC Corporation.

The surfactant used in the ink composition of the present invention may be one compound or a mixture of two or more compounds.

### 1.6 Other Additives

The ink composition of the present invention may contain an additive depending on intended characteristics. Examples of the additive include a monomer/polymer other than the second component, an antistatic agent, a coupling agent, an antioxidant, a pH adjusting agent, and a reduction inhibitor.

### Monomer/Polymer other than Second Component

Examples the monomer/polymer other than the second component include styrene, methylstyrene, chloromethylstyrene, N-cyclohexylmaleimide, N-phenylmaleimide, vinyltoluene, crotonic acid, α-chloroacrylic acid, cinnamic acid, maleic acid, fumaric acid, itaconic acid, citraconic acid, mesacone acid, a polystyrene macromonomer, and a polymethyl methacrylate macromonomer.

### Antistatic Agent

The antistatic agent can be used for preventing charging of the composition, and is preferably used in an amount of 0 to 20% by weight in the composition. As the antistatic agent, a known antistatic agent can be used. Specific examples thereof include metal an oxide such as tin oxide, tin oxide/antimony oxide composite oxide, or tin oxide/indium oxide composite oxide, and a quaternary ammonium salt. The antistatic agent may be used singly or in combination of two or more kinds thereof.

### Coupling Agent

The coupling agent is not particularly limited, and a known coupling agent such as a silane coupling agent can be used for the purpose of improving adhesion to glass or ITO, or the like. The silane coupling agent mainly has a role as an adhesion aid for bonding a sealing agent for the organic electroluminescent element of the present invention to an organic EL panel and a protective substrate. The coupling agent is preferably used by being added so as to be 10 parts by weight or less relative to 100 parts by weight of the solid content of the composition (the residue obtained by removing a solvent from the composition). The coupling agent may be used singly or in combination of two or more kinds thereof.

Examples of the silane coupling agent include a trialkoxysilane compound and a dialkoxysilane compound. Preferable examples thereof include γ-vinylpropyltrimethoxysilane, γ-vinylpropyltriethoxysilane, γ-acryloylpropylmethyldimethoxysilane, γ-acryloylpropyltrimethoxysilane, γ-acryloylpropylmethyldiethoxysilane, γ-acryloylpropyltriethoxysilane, γ-methacryloylpropylmethyldimethoxysilane, γ-methacryloylpropyltrimethoxysilane, γ-methacryloylpropylmethyldiethoxysilane, γ-methacryloylpropyltriethoxysilane, γ-glycidoxypropylmethyldimethoxysilane, γ-glycidoxypropyltrimethoxysilane, γ-glycidoxypropylmethyldiethoxysilane, γ-glycidoxypropyltriethoxysilane, γ-aminopropylmethyldimethoxysilane γ-aminopropyltrimethoxysilane, γ-aminopropylmethyldiethoxysilane, γ-aminopropyltriethoxysilane, N-aminoethyl-γ-iminopropylmethyldimethoxysilane, N-aminoethyl-γ-aminopropyltrimethoxysilane, N-aminoethyl-γ-aminopropyltriethoxysilane, N-phenyl-γ-aminopropyltrimethoxysilane, N-phenyl-γ-aminopropyltriethoxysilane, N-phenyl-γ-aminopropylmethyldimethoxysilane, N-phenyl-γ-aminopropylmethyldiethoxysilane, γ-mercaptopropylmethyldimethoxysilane, γ-mercaptopropylmethyldiethoxysilane, γ-mercaptopropyltriethoxysilane, γ-isocyanatopropylmethyldiethoxysilane, and γ-isocyanatopropyltriethoxysilane.

Among these compounds, γ-vinylpropyltrimethoxysilane, γ-acryloylpropyltrimethoxysilane, γ-methacryloylpropyltrimethoxysilane, γ-glycidoxypropyltrimethoxysilane, γ-isocyanatopropyltriethoxysilane, and the like are particularly preferable.

Polycondensates of these compounds may also be used. Specific examples thereof include Coatosil MP200 (manufactured by MOMENTIVE).

The blending amount of the silane coupling agent is not particularly limited, but a preferable lower limit is 0.1 parts by weight, and a preferable upper limit is 10 parts by weight relative to 100 parts by weight of the (meth)acrylate-based monomer. If the blending amount of the silane coupling agent is less than 0.1 parts by weight, an effect of adding the silane coupling agent is hardly obtained in some cases. If the blending amount of the silane coupling agent exceeds 10 parts by weight, an alkoxy group of the excess silane coupling agent is decomposed to generate alcohol, and therefore this may deteriorate the organic electroluminescent element. A more preferable lower limit of the blending amount of the silane coupling agent is 0.5 parts by weight, and a more preferable upper limit thereof is 5 parts by weight.

### Antioxidant

By inclusion of the antioxidant in the composition, deterioration of a cured film obtained from the composition can be suppressed and prevented in a case where the cured film is exposed to high temperature or light. The antioxidant is preferably added and used in an amount of 0 to 3 parts by weight relative to 100 parts by weight of the solid content of the composition excluding the antioxidant (the residue obtained by removing a solvent from the composition). The antioxidant may be used singly or in combination of two or more kinds thereof.

Examples of the antioxidant include a hindered amine-based compound and a hindered phenol-based compound. Specific examples thereof include IRGAFOS XP40, IRGAFOS XP60, IRGANOX 1010, IRGANOX 1035, IRGANOX 1076, IRGANOX 1135, and IRGANOX 1520L (all of which are trade names, manufactured by BASF).

### 1.7 Characteristics of Ink Composition

The moisture content of the ink composition is preferably 0.1% by weight or less, and more preferably 0.06% by weight or less relative to 100% by weight of the composition. An electric circuit in which an optical semiconductor such as an organic electroluminescent element is disposed is easily deteriorated by moisture. Therefore, the water content in the composition is preferably minimized. The moisture content in the composition can be determined by weighing about 0.1 g of a sample, heating the sample to 150° C. using a Karl Fischer moisture meter, and measuring the amount of moisture generated at that time (solid vaporization method).

In a case where the ink composition of the present invention is used as an inkjet ink, the ink composition can be used by optimizing various parameters such as viscosity, surface tension, and solvent boiling point for inkjet printing, and good inkjet printability (for example, drawing performance) is exhibited.

The viscosity at a temperature (ejection temperature) at which the ink composition is ejected from an inkjet head is usually 1 to 50 mPa·s, preferably 5 to 25 mPa·s, and more preferably 8 to 15 mPa·s. A viscosity within the above range improves jetting accuracy by an inkjet applying method. A viscosity less than 15 mPa·s is preferable from a viewpoint of inkjet ejectability.

Jetting is often performed at normal temperature (25° C.). Therefore, the viscosity of the ink composition of the invention at 25° C. is usually 1 to 50 mPa·s, preferably 5 to 45 mPa·s, and more preferably 5 to 25 mPa·s. A viscosity less than 25 mPa·s at 25° C. is preferable from a viewpoint of inkjet ejectability.

The surface tension of the ink composition of the present invention at 25° C. is 15 to 35 mN/m, and preferably 18 to 32 mN/m. A surface tension within the above range can form good droplets by jetting and can form a meniscus.

A method for applying the ink composition of the present invention includes a step of applying the above inkjet ink by an inkjet applying method to form a coating film and a step of curing the coating film.

By appropriately selecting components to be contained, the ink composition of the present invention can be ejected by various methods. The ink composition of the present invention can be applied in a predetermined pattern by an inkjet applying method.

In a case where the ink composition of the present invention is applied by an inkjet applying method, various methods are used depending on a method for ejecting ink. Examples of the ejection method include a piezoelectric element method, a bubble jet (registered trademark) method, a continuous jet method, and an electrostatic induction method.

A preferable ejection method for applying the ink composition of the present invention is the piezoelectric element method. A head used in this piezoelectric element method is an on-demand inkjet applying head including a nozzle forming substrate having a plurality of nozzles, a pressure generating element including a piezoelectric material disposed facing the nozzles and a conductive material, and ink filling the periphery of the pressure generating element. The pressure generating element is displaced by an applied voltage, and small droplets of the ink are ejected from the nozzles.

An inkjet applicator is not limited to a configuration in which an applying head and an ink container are formed as separate bodies but may be a configuration in which the applying head and the ink container are integrally formed so as to be unseparable from each other. The ink container may be integrally formed so as to be separable or unseparable from the applying head and mounted on a carriage. Alternatively, the ink container may be disposed at a fixing portion of the apparatus to supply ink to the applying head via an ink supply member, for example, a tube.

In a case where an ink tank has a configuration for applying a preferable negative pressure to the applying head, an absorber may be disposed in an ink containing portion of the ink tank, or the ink tank may include a flexible ink containing bag and a spring portion that applies an urging force in a direction to expand the internal volume of the ink containing bag, for example. The applicator may adopt a serial applying type or a line printer type in which applying elements are aligned over a range corresponding to the entire width of an applying medium.

### 2. Cured Product Formed Using Ink Composition

The cured product (including a patterned cured product) of the present invention can be obtained through a step of forming a coating film using the ink composition of the present invention, for example, as an inkjet ink and applying the ink composition by an inkjet applying method, and a step of curing the coating film.

In a case where the ink composition of the present invention is irradiated with ultraviolet light, visible light, or the like, the irradiation amount of the light (exposure amount) depends on a composition ratio in the ink composition of the present invention, and is preferably 100 to 5,000 mJ/cm², more preferably 300 to 4,000 mJ/cm², and still more preferably 500 to 3,000 mJ/cm² as measured with an integrated photometer UIT-201 equipped with a light receiving device UVD-365PD, manufactured by Ushio Electric Co., Ltd. The wavelength of the ultraviolet light or visible light for irradiation is preferably 200 to 500 nm, and more preferably 250 to 450 nm. Note that the exposure amount described below is a value measured with the integrated photometer UIT-201 equipped with a light receiving device UVD-365PD, manufactured by Ushio Electric Co., Ltd. An exposure machine is not particularly limited as long as including an electrodeless lamp, a low-pressure mercury lamp, a high-pressure mercury lamp, an extra-high pressure mercury lamp, a metal halide lamp, a halogen lamp, an LED light source, and the like, and emitting ultraviolet light, visible light, or the like in a range of 200 to 500 nm.

Incidentally, in a case where the ink composition is printed in a pattern using an inkjet applying method, a patterned cured film (patterned cured film) is formed. Here, unless otherwise particularly mentioned, in the following description, the cured film includes a patterned cured film.

The total light transmittance of a cured product of the ink composition is preferably 80% or more, more preferably 85% or more, and still more preferably 90% or more. This is because a too low total light transmittance of the cured product easily lowers a light extraction efficiency from an element and also deteriorates a design property in a case where the cured product is used as a sealing agent for an organic electroluminescent element or the like. An upper limit value of the total light transmittance of the cured product of the sealing agent may be generally about 99%.

A refractive index of the cured product of the ink composition closer to the refractive index of an adjacent layer in a device is more preferable because reflection at a layer interface is suppressed and the transmittance of light is high.

The refractive index of the cured product of the ink composition is preferably 1.6 to 2.0, more preferably 1.65 to 2.0, and still more preferably 1.7 to 2.0.

A lower dielectric constant of the cured product of the ink composition is more preferable because delay and noise of a signal can be prevented.

The dielectric constant of the cured product of the ink composition is preferably 1.5 to 4.6, more preferably 2.0 to 4.3, still more preferably 2.5 to 4.0, and preferably 3.0 to 3.9.

### 3. Substrate with Cured Film

A substrate with the cured film according to the present invention includes a film substrate or a silicon wafer substrate and a cured film or a patterned cured film formed on the substrate by the above-described method of forming a cured film. For example, the substrate with the cured film is obtained by applying the ink composition of the present invention onto a substrate such as a polyimide film, a glass substrate, a metal foil, or a silicon wafer substrate on which a thin film or an organic thin film device having an optical function is formed by an inkjet applying method, and then subjecting the ink composition to UV treatment as described above to form a cured film.

The cured film of the present invention is preferably formed on a substrate such as a polyimide film, a glass substrate, a metal foil, or a silicon wafer substrate on which the above-described thin film or organic thin film device having an optical function is formed. However, the type of the substrate is not particularly limited thereto, and the cured film can be formed on a known substrate.

Examples of a substrate applicable to the present invention include: a substrate made of a metal such as copper, brass, phosphor bronze, beryllium copper, aluminum, gold, silver, nickel, tin, chromium, or stainless steel (a substrate having these metals on a surface thereof may be used); a substrate made of a ceramic such as aluminum oxide (alumina), aluminum nitride, zirconium oxide (zirconia), silicate of zirconium (zircon), magnesium oxide (magnesia), aluminum titanate, barium titanate, lead titanate (PT), lead zirconate titanate (PZT), lead lanthanum zirconate titanate (PLZT), lithium niobate, lithium tantalate, cadmium sulfide, molybdenum sulfide, beryllium oxide (beryllia), silicon oxide (silica), silicon carbide, silicon nitride, boron nitride, zinc oxide, mullite, ferrite, steatite, holsterite, spinel, or spodumene (a substrate having these ceramics on a surface thereof may be used); a substrate made of a resin such as a polyethylene terephthalate (PET) resin, a polybutylene terephthalate (PBT) resin, a polycyclohexylenedimethylene terephthalate (PCT) resin, a polyphenylene sulfide (PPS) resin, a polycarbonate resin, a polyacetal resin, a polyphenylene ether resin, a polyamide resin, a polyarylate resin, a polysulfone resin, a polyether sulfone resin, a polyether imide resin, a polyamideimide resin, an epoxy resin, an acrylic resin, Teflon (registered trademark), a thermoplastic elastomer, or a liquid crystal polymer (a substrate having these resins on a surface thereof may be used); a semiconductor substrate such as silicon, germanium, or gallium arsenide; a glass substrate; a substrate on which an electrode material such as tin oxide, zinc oxide, ITO, or ATO is formed; a gel sheet such as αGEL, βGEL, θGEL, or γ GEL (all of which are registered trademarks of Taica Corporation); and a glass epoxy substrate, a glass composite substrate, a paper phenol substrate, a paper epoxy substrate, a green epoxy substrate, and a BT resin substrate meeting various standards such as FR-1, FR-3, FR-4, CEM-3, and E668.

### 4. Organic Thin Film Device

The organic thin film device of the present invention includes the above-described cured film or substrate with a cured film. A flexible organic thin film device can be obtained by using the cured film or the substrate with a cured film according to the present invention. The cured film of the present invention can also be applied to a silicon wafer substrate.

### 4.1 Organic Electroluminescent Element

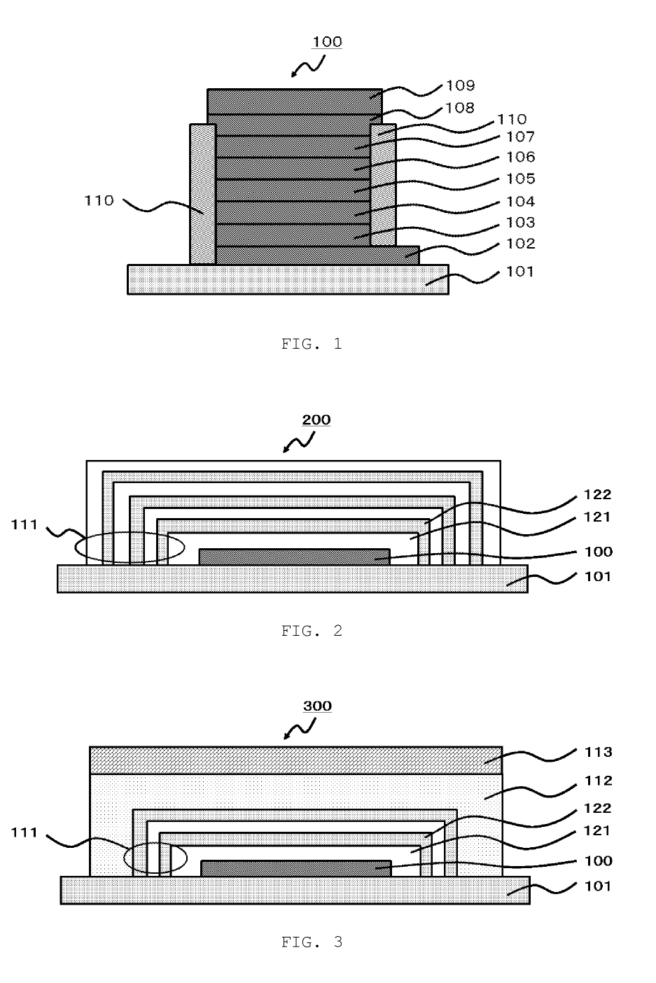

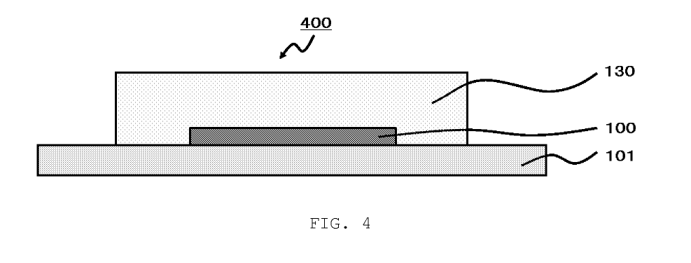

Hereinafter, a top emission structure which is an example of the organic electroluminescent element according to the present embodiment will be described in detail with reference to the drawings. FIG. 1 is a schematic cross-sectional view illustrating the organic electroluminescent element according to the present embodiment. FIGS. 2 and 3 are schematic sectional views illustrating the organic electroluminescent element having a sealing structure according to the present embodiment.

### Structure of Organic Electroluminescent Element

An organic electroluminescent element 100 illustrated in FIG. 1 includes a substrate 101, a bank 110 disposed on the substrate 101, a positive electrode 102 disposed on the substrate 101, a hole injection layer 103 disposed on the positive electrode 102, a hole transport layer 104 disposed on the hole injection layer 103, a light emitting layer 105 disposed on the hole transport layer 104, an electron transport layer 106 disposed on the light emitting layer 105, an electron injection layer 107 disposed on the electron transport layer 106, a negative electrode 108 disposed on the electron injection layer 107, and a capping layer 109 disposed on the negative electrode 108.

Incidentally, the organic electroluminescent element 100 may be configured, by reversing the manufacturing order, to include, for example, the substrate 101, the bank 110 disposed on the substrate 101, the negative electrode 108 disposed on the substrate 101, the electron injection layer 107 disposed on the negative electrode 108, the electron transport layer 106 disposed on the electron injection layer 107, the light emitting layer 105 disposed on the electron transport layer 106, the hole transport layer 104 disposed on the light emitting layer 105, the hole injection layer 103 disposed on the hole transport layer 104, the positive electrode 102 disposed on the hole injection layer 103, and the capping layer 109 disposed on the positive electrode 102.

An organic electroluminescent element 200 having a sealing structure illustrated in FIG. 2 includes a barrier layer 111 having a structure in which a passivation layer 121 and a buffer layer 122 are repeatedly laminated on the organic electroluminescent element 100. An organic electroluminescent element 300 having a sealing structure illustrated in FIG. 3 includes the barrier layer 111 having a structure in which the passivation layer 121 and the buffer layer 122 are repeatedly laminated on the organic electroluminescent element 100, and a barrier film 113 having an adhesive layer 112 disposed so as to cover the barrier layer 111. In FIGS. 2 and 3, at least one pair of the passivation layer 121 and the buffer layer 122 constituting the barrier layer 111 is required. Usually, 1 to 20 pairs are used. The pair does not need to be present on the outermost side of the barrier layer 111. The order of forming the passivation layer 121 and the buffer layer 122 constituting the barrier layer 111 on the organic electroluminescent element 100 is arbitrary. A member formed of a color filter, a circular polarization plate, a touch panel, or the like may be further included on the barrier layer 111 in FIG. 2, and on the barrier film 113 in FIG. 3. Note that the member may include an adhesive layer or a barrier layer.

An inorganic material is used for the passivation layer 121. If a dense film is formed, the film exhibits high gas barrier performance. However, it is difficult to form a film without a pinhole, and a gas barrier property is lowered due to the pinhole. Therefore, by sandwiching the buffer layer 122 between the passivation layers 121, the pinhole is prevented from penetrating the passivation layer 121, or the pinhole is filled. In addition, by sandwiching the flexible buffer layer 122 between the hard passivation layers 121, flexibility can be imparted to the laminated barrier layer 111. A cured product formed from the ink composition of the present invention is used for the buffer layer 122 in FIGS. 2 and 3.

An organic electroluminescent element 400 having a sealing structure illustrated in FIG. 4 includes a barrier layer 130 having a single configuration on the organic electroluminescent element 100. The organic electroluminescent element 400 having the sealing structure in FIG. 4 has the most ideal configuration. The single barrier layer 130 has a high gas barrier function, high optical characteristics, and high film physical characteristics. In FIG. 4, a member formed of a color filter, a circular polarization plate, a touch panel, or the like may be further included on the barrier layer 130. Note that the member may include an adhesive layer.

A cured product formed from the ink composition of the present invention can be used for the barrier layer 130 in FIG. 4.

Furthermore, an edge seal may be disposed in order to block gas such as steam entering from a lateral direction of the laminated device as described above. The edge seal is also made of an existing material, and is made of, for example, a glass frit, a photocurable resin, or an adhesive seal.

All of the above layers are not indispensable. A minimum constitutional unit is constituted by the organic electroluminescent element 100 including the positive electrode 102, the light emitting layer 105, and the negative electrode 108 and a cured film as the barrier layer 130 covering the organic electroluminescent element 100. The hole injection layer 103, the hole transport layer 104, the electron transport layer 106, the electron injection layer 107, the capping layer 109, the passivation layer 121, the buffer layer 122, the bank 110, and the edge seal are arbitrarily disposed. Each of the above layers may be formed of a single layer or a plurality of layers.

### Substrate in Organic Electroluminescent Element

The substrate 101 serves as a support of the organic electroluminescent element 100, and usually, quartz, glass, a metal, a plastic, and the like are used. The substrate 101 is formed into a plate shape, a film shape, or a sheet shape according to a purpose, and for example, a glass plate, a metal plate, a metal foil, a plastic film, and a plastic sheet are used therefor. Among these examples, a glass plate and a plate made of a transparent synthetic resin such as polyester, polymethacrylate, polycarbonate, polyimide, or polysulfone are preferable. For a glass substrate, soda lime glass, alkali-free glass, and the like are used. The thickness is only required to be sufficient for maintaining mechanical strength. Therefore, the thickness is only required to be 0.2 mm or more, for example. An upper limit value of the thickness is, for example, 2 mm or less, and preferably 1 mm or less. Regarding a material of glass, glass having fewer ions eluted from the glass is desirable, and therefore alkali-free glass is preferable. However, soda lime glass which has been subjected to barrier coating with SiO₂ or the like is also commercially available, and therefore this soda lime glass can be used. Furthermore, the substrate 101 may be provided with a gas barrier film such as a dense silicon oxide film on at least one surface in order to increase a gas barrier property. Particularly in a case of using a plate, a film, or a sheet made of a synthetic resin having a low gas barrier property as the substrate 101, a gas barrier film is preferably provided.

### Positive Electrode in Organic Electroluminescent Element

The positive electrode 102 plays a role of injecting a hole into the light emitting layer 105. Incidentally, in a case where the hole injection layer 103 and/or the hole transport layer 104 are/is disposed between the positive electrode 102 and the light emitting layer 105, a hole is injected into the light emitting layer 105 through these layers.

Examples of a material to form the positive electrode 102 include an inorganic compound and an organic compound. Examples of the inorganic compound include a metal (aluminum, gold, silver, nickel, palladium, chromium, and the like), a metal oxide (indium oxide, tin oxide, indium-tin oxide (ITO), indium-zinc oxide (IZO), and the like), a metal halide (copper iodide and the like), copper sulfide, carbon black, ITO glass, and Nesa glass. Examples of the organic compound include an electrically conductive polymer including polythiophene such as poly(3-methylthiophene), polypyrrole, and polyaniline. In addition to these compounds, a material can be appropriately selected for use from materials used as a positive electrode of an organic electroluminescent element.

A resistance of a transparent electrode is not limited as long as a sufficient current can be supplied for light emission of a luminescent element. However, a low resistance is desirable from a viewpoint of consumption power of the luminescent element. For example, an ITO substrate having a resistance of 300 Ω/□ or less functions as an element electrode. However, a substrate having a resistance of about 10 Ω/□ can be also supplied at present, and therefore it is particularly desirable to use a low resistance product having a resistance of, for example, 100 to 5 Ω/□, preferably 50 to 5 Ω/□. The thickness of ITO can be arbitrarily selected according to a resistance value, but an ITO having a thickness of 50 to 300 nm is often used.

### Hole Injection Layer and Hole Transport Layer in Organic Electroluminescent Element

The hole injection layer 103 plays a role of efficiently injecting a hole that migrates from the positive electrode 102 into the light emitting layer 105 or the hole transport layer 104. The hole transport layer 104 plays a role of efficiently transporting a hole injected from the positive electrode 102 or a hole injected from the positive electrode 102 through the hole injection layer 103 into the light emitting layer 105. The hole injection layer 103 and the hole transport layer 104 are each formed by laminating and mixing one or more kinds of hole injection/transport materials, or by a mixture of a hole injection/transport material and a polymer binder. Furthermore, a layer may be formed by adding an inorganic salt such as iron(III) chloride to the hole injection/transport material.

A hole injection/transport substance needs to efficiently inject/transport a hole coming from a positive electrode between electrodes to which an electric field is applied, and desirably has a high hole injection efficiency and transports an injected hole efficiently. For this purpose, a substance which has low ionization potential, large hole mobility, and further has excellent stability, and in which impurities serving as traps are not easily generated at the time of manufacturing and at the time of use, is preferable.

As a material to be used as the hole injection/transport substance, any material can be selected from known materials to be used. Specific examples thereof include a carbazole derivative, a triarylamine derivative, a stilbene derivative, a phthalocyanine derivative, a pyrazoline derivative, a hydrazone-based compound, a benzofuran derivative, and a thiophene derivative.

### Light Emitting Layer in Organic Electroluminescent Element

The light emitting layer 105 emits light by recombining a hole injected from the positive electrode 102 and an electron injected from the negative electrode 108 between electrodes to which an electric field is applied. A material to form the light emitting layer 105 is only required to be a compound which is excited by recombination between a hole and an electron and emits light (luminescent compound), and is preferably a compound which can form a stable thin film shape and exhibits a strong light emission (fluorescence) efficiency in a solid state.

The light emitting layer may be formed of a single layer or a plurality of layers, and each layer is formed of a material for a light emitting layer (a host material and a dopant material). Each of the host material and the dopant material may be formed of a single kind, or a combination of a plurality of kinds. The dopant material may be included in the host material wholly or partially. Regarding a doping method, doping can be performed by a co-deposition method with a host material, or alternatively, a dopant material may be mixed in advance with a host material, and then vapor deposition may be performed simultaneously.

The amount of use of a host material depends on the kind of the host material, and is only required to be determined according to a characteristic of the host material. The reference of the amount of use of a host material is preferably from 50 to 99.999% by weight, more preferably from 80 to 99.95% by weight, and still more preferably from 90 to 99.9% by weight with respect to the total amount of a material for a light emitting layer.

The amount of use of a dopant material depends on the kind of the dopant material, and is only required to be determined according to a characteristic of the dopant material. The reference of the amount of use of a dopant is preferably from 0.001 to 50% by weight, more preferably from 0.05 to 20% by weight, and still more preferably from 0.1 to 10% by weight with respect to the total amount of a material for a light emitting layer. The amount of use within the above range is preferable, for example, from a viewpoint of being able to prevent a concentration quenching phenomenon.

Examples of a material used for the light emitting layer include a fluorescent material and a phosphorescent material, and these materials can be arbitrarily selected from known materials to be used. Specific examples of the fluorescent material include a fused ring derivative such as anthracene or pyrene and a fluorene derivative as a host material. A dopant material can be selected from various materials depending on a desired emission color. Specific examples of the phosphorescent material include a carbazole derivative as a host material and an iridium-based metal complex depending on an emission color as a dopant material.

### Electron Injection Layer and Electron Transport Layer in Organic Electroluminescent Element

The electron injection layer 107 plays a role of efficiently injecting an electron migrating from the negative electrode 108 into the light emitting layer 105 or the electron transport layer 106. The electron transport layer 106 plays a role of efficiently transporting an electron injected from the negative electrode 108 or an electron injected from the negative electrode 108 through the electron injection layer 107 into the light emitting layer 105. The electron transport layer 106 and the electron injection layer 107 are each formed by laminating and mixing one or more kinds of electron transport/injection materials, or by a mixture of an electron transport/injection material and a polymer binder.

The electron injection/transport layer manages injection of an electron from a negative electrode and further manages transport of an electron, and desirably has a high electron injection efficiency and can efficiently transport an injected electron. For this purpose, a substance which has high electron affinity and large electron mobility, and further has excellent stability, and in which impurities serving as traps are not easily generated at the time of manufacturing and at the time of use, is preferable. However, when a transport balance between a hole and an electron is considered, in a case where the electron injection/transport layer mainly plays a role of efficiently preventing a hole coming from a positive electrode from flowing toward a negative electrode side without being recombined, even if electron transport ability is not so high, the electron injection/transport layer has an effect of enhancing a light emission efficiency equally to a material having high electron transport ability. Therefore, the electron injection/transport layer in the present embodiment may also include a function of a layer capable of efficiently preventing migration of a hole.

A material (electron transport material) for forming the electron transport layer 106 or the electron injection layer 107 can be arbitrarily selected for use from compounds conventionally used as electron transfer compounds in a photoconductive material, and known compounds that are used in an electron injection layer and an electron transport layer of an organic electroluminescent element.

A material used in an electron transport layer or an electron injection layer preferably includes at least one selected from a compound formed of an aromatic ring or a heteroaromatic ring including one or more kinds of atoms selected from carbon, hydrogen, oxygen, sulfur, silicon, and phosphorus atoms, a pyrrole derivative and a fused ring derivative thereof, and a metal complex having an electron-accepting nitrogen atom. Specific examples of the material include a fused ring-based aromatic ring derivative of naphthalene, anthracene, or the like, a styryl-based aromatic ring derivative represented by 4,4′-bis(diphenylethenyl)biphenyl, a perinone derivative, a coumarin derivative, a naphthalimide derivative, a quinone derivative such as anthraquinone or diphenoquinone, a phosphorus oxide derivative, a carbazole derivative, and an indole derivative. Examples of the metal complex having an electron-accepting nitrogen atom include a hydroxyazole complex such as a hydroxyphenyloxazole complex, an azomethine complex, a tropolone metal complex, a flavonol metal complex, and a benzoquinoline metal complex. These materials are used singly, but may also be used in a mixture with other materials.

The electron transport layer or the electron injection layer may further contain a substance capable of reducing a material to form the electron transport layer or the electron injection layer. As this reducing substance, various substances are used as long as having reducibility to a certain extent. For example, at least one selected from the group consisting of an alkali metal, an alkaline earth metal, a rare earth metal, an oxide of an alkali metal, a halide of an alkali metal, an oxide of an alkaline earth metal, a halide of an alkaline earth metal, an oxide of a rare earth metal, a halide of a rare earth metal, an organic complex of an alkali metal, an organic complex of an alkaline earth metal, and an organic complex of a rare earth metal, can be suitably used.

Preferable examples of the reducing substance include alkali metals such as Na (work function 2.36 eV), K (work function 2.28 eV), Rb (work function 2.16 eV), and Cs (work function 1.95 eV); and alkaline earth metals such as Ca (work function 2.9 eV), Sr (work function 2.0 to 2.5 eV), and Ba (work function 2.52 eV). A reducing substance having a work function of 2.9 eV or less is particularly preferable. Among these substances, an alkali metal such as K, Rb, or Cs is a more preferable reducing substance, Rb or Cs is a still more preferable reducing substance, and Cs is the most preferable reducing substance. These alkali metals have particularly high reducing ability, and can enhance emission luminance of an organic electroluminescent element or can lengthen a lifetime thereof by adding the alkali metals in a relatively small amount to a material to form an electron transport layer or an electron injection layer. Furthermore, as the reducing substance having a work function of 2.9 eV or less, a combination of two or more kinds of these alkali metals is also preferable, and particularly, a combination including Cs, for example, a combination of Cs with Na, a combination of Cs with K, a combination of Cs with Rb, or a combination of Cs with Na and K, is preferable. By inclusion of Cs, reducing ability can be efficiently exhibited, and emission luminance of an organic electroluminescent element is enhanced or a lifetime thereof is lengthened by adding Cs to a material to form an electron transport layer or an electron injection layer.

### Negative Electrode in Organic Electroluminescent Element

The negative electrode 108 plays a role of injecting an electron into the light emitting layer 105 through the electron injection layer 107 and the electron transport layer 106.

A material to form the negative electrode 108 is not particularly limited as long as being a substance capable of efficiently injecting an electron into an organic layer. However, a material similar to the materials to form the positive electrode 102 can be used. Among these materials, a metal such as tin, indium, calcium, aluminum, silver, copper, nickel, chromium, gold, platinum, iron, zinc, lithium, sodium, potassium, cesium, or magnesium, and an alloy thereof (a magnesium-silver alloy, a magnesium-indium alloy, an aluminum-lithium alloy such as lithium fluoride/aluminum, or the like) are preferable. In order to enhance element characteristics by increasing an electron injection efficiency, lithium, sodium, potassium, cesium, calcium, magnesium, or an alloy containing these low work function-metals is effective. However, many of these low work function-metals are generally unstable in air. In order to ameliorate this problem, for example, a method using an electrode having high stability obtained by doping an organic layer with a trace amount of lithium, cesium, or magnesium is known. Other examples of a dopant that can be used include an inorganic salt such as lithium fluoride, cesium fluoride, lithium oxide, or cesium oxide. However, the dopant is not limited thereto.

Furthermore, in order to protect an electrode, a passivation layer formed of, for example, a metal such as platinum, gold, silver, copper, iron, tin, aluminum, or indium, an alloy using these metals, or an inorganic substance such as silica, titania, or silicon nitride is laminated. Furthermore, in an element having a top emission structure, a capping layer having a high refractive index is laminated on a negative electrode or a passivation layer in order to improve a light extraction efficiency, and a cured film formed from the ink composition of the present invention is further laminated thereon. A method for manufacturing these electrodes is not particularly limited as long as being capable of conduction, such as resistance heating, electron beam, sputtering, ion plating, or coating. The capping layer is preferably formed using a known material.

### Binder that may be Used in Each Layer

The materials used in the above-described hole injection layer, hole transport layer, light emitting layer, electron transport layer, and electron injection layer can form each layer by being used singly. However, it is also possible to use the materials by dispersing the materials in a solvent-soluble resin such as polyvinyl chloride, polycarbonate, polystyrene, poly(N-vinylcarbazole), polymethyl methacrylate, polybutyl methacrylate, polyester, polysulfone, polyphenylene oxide, polybutadiene, a hydrocarbon resin, a ketone resin, a phenoxy resin, polyamide, ethyl cellulose, a vinyl acetate resin, an ABS resin, or a polyurethane resin; or a curable resin such as a phenolic resin, a xylene resin, a petroleum resin, a urea resin, a melamine resin, an unsaturated polyester resin, an alkyd resin, an epoxy resin, or a silicone resin, as a polymer binder.

### Method for Manufacturing Organic Electroluminescent Element

Each layer constituting an organic electroluminescent element can be formed by forming thin films of materials to constitute each layer by a method such as a vapor deposition method, resistance heating vapor deposition, electron beam vapor deposition, sputtering, a molecular lamination method, a printing method, a spin coating method, a casting method, or a coating method. The film thickness of each layer thus formed is not particularly limited, and can be appropriately set according to a property of a material, but is usually within a range of 2 nm to 5000 nm. The film thickness can be usually measured using a crystal oscillation type film thickness measuring apparatus or the like. In a case of forming a thin film using a vapor deposition method, vapor deposition conditions depend on the kind of a material, an intended crystal structure of a film, an association structure, and the like. It is preferable to appropriately set the vapor deposition conditions generally in ranges of a boat heating temperature of +50 to +400° C., a degree of vacuum of 10⁻⁶ to 10⁻³ Pa, a rate of vapor deposition of 0.01 to 50 nm/sec, a substrate temperature of −150 to +300° C., and a film thickness of 2 nm to 5 μm.

Next, as an example of a method for manufacturing an organic electroluminescent element, a method for manufacturing an organic electroluminescent element formed of positive electrode/hole injection layer/hole transport layer/light emitting layer including host material and dopant material/electron transport layer/electron injection layer/negative electrode will be described. A thin film of a positive electrode material is formed on an appropriate substrate by a vapor deposition method or the like to manufacture a positive electrode, and then thin films of a hole injection layer and a hole transport layer are formed on this positive electrode. A thin film is formed thereon by co-depositing a host material and a dopant material to obtain a light emitting layer. An electron transport layer and an electron injection layer are formed on this light emitting layer, and a thin film formed of a substance for a negative electrode is further formed by a vapor deposition method or the like to obtain a negative electrode. An intended organic electroluminescent element is thereby obtained. Incidentally, in manufacturing the above organic electroluminescent element, it is also possible to manufacture the element by reversing the manufacturing order, that is, in order of a negative electrode, an electron injection layer, an electron transport layer, a light emitting layer, a hole transport layer, a hole injection layer, and a positive electrode.

After the electrode is manufactured as described above, a capping layer is formed by a method such as a vapor deposition method, and a passivation layer is formed by a sputtering method or a chemical vapor deposition method. Thereafter, the ink composition of the present invention is applied and cured by a printing method. Thereafter, a passivation layer is formed by a sputtering method or a chemical vapor deposition method. In the present invention, the ink composition can be applied directly onto an electrode or the like without forming a passivation film.

As a material used for the capping layer, an organic material having an appropriate refractive index is selected according to the refractive index of a negative electrode as a base, and a material constituting the organic electroluminescent element can also be used. As a material used for the passivation layer, SiO₂, SiCN, SiCNO, SiNx, Al₂O₃, or the like can be used. The ink composition of the present invention has good resistance to a sputtering step or a chemical vapor deposition step which is a step of forming a passivation layer, and therefore can maintain good optical characteristics even after the passivation layer is formed.

In a case where a direct current voltage is applied to the organic electroluminescent element thus obtained, it is only required to apply the voltage by using a positive electrode as a positive polarity and using a negative electrode as a negative polarity. By applying a voltage of about 2 to 40 V, light emission can be observed from a transparent or semitransparent electrode side (the positive electrode or the negative electrode, or both the electrodes). This organic electroluminescent element also emits light also in a case where a pulse current or an alternating current is applied. Note that a waveform of an alternating current applied may be any waveform.

### Application Examples of Organic Electroluminescent Element

An organic electroluminescent element sealed with a cured film formed from the ink composition of the present invention can also be applied to a display apparatus, a lighting apparatus, or the like. The display apparatus or lighting apparatus including an organic electroluminescent element can be manufactured by a known method such as connecting the organic electroluminescent element according to the present embodiment to a known driving apparatus, and can be driven by appropriately using a known driving method such as direct driving, pulse driving, or alternating driving.

Examples of the display apparatus include a panel display such as a color flat panel display; and a flexible display such as a flexible color organic electroluminescent (EL) display (see, for example, JP 10-335066 A, JP 2003-321546 A, and JP 2004-281086 A). Examples of a display method of the display include a matrix method and/or a segment method. Note that the matrix display and the segment display may co-exist in the same panel.

The matrix refers to a system in which pixels for display are arranged two-dimensionally as in a lattice form or a mosaic form, and characters or images are displayed by an assembly of pixels. The shape or size of a pixel depends on intended use. For example, for display of images and characters of a personal computer, a monitor, or a television, square pixels each having a size of 300 μm or less on each side are usually used, and in a case of a large-sized display such as a display panel, pixels having a size in the order of millimeters on each side are used. In a case of monochromic display, it is only required to arrange pixels of the same color. However, in a case of color display, display is performed by arranging pixels of red, green, and blue. In this case, typically, delta type display and stripe type display are available. For this matrix driving method, either a line sequential driving method or an active matrix method may be employed. The line sequential driving method has an advantage of having a simpler structure. However, in consideration of operation characteristics, the active matrix method may be superior. Therefore, it is necessary to use the line sequential driving method and the active matrix method properly according to intended use.

In the segment method (type), a pattern is formed so as to display predetermined information, and a determined region emits light. Examples of the segment method include display of time or temperature in a digital clock or a digital thermometer, display of a state of operation in an audio instrument or an electromagnetic cooker, and panel display in an automobile.

Examples of the lighting apparatus include a lighting apparatuses for indoor lighting or the like, and a backlight of a liquid crystal display apparatus (see, for example, JP 2003-257621 A, JP 2003-277741 A, and JP 2004-119211 A). The backlight is mainly used for enhancing visibility of a display apparatus that is not self-luminous, and is used in a liquid crystal display apparatus, a timepiece, an audio apparatus, an automotive panel, a display plate, a sign, and the like. Particularly, in a backlight for use in a liquid crystal display apparatus, among the liquid crystal display apparatuses, for use in a personal computer in which thickness reduction has been a problem to be solved, in consideration of difficulty in thickness reduction because a conventional type backlight is formed from a fluorescent lamp or a light guide plate, a backlight using the luminescent element according to the present embodiment is characterized by its thinness and lightweightness.

### 4.2 Other Devices

Since the ink composition of the present invention has a high refractive index, the ink composition can be generally used for a light extraction structure in an optical device in addition to the above-described organic electroluminescent element. The light extraction structure is, for example, a two-dimensional or three-dimensional structure in which the refractive index is suitably adjusted. Specific examples thereof include a multilayer structure formed such that a difference in refractive index between adjacent layers is reduced, a three-dimensional structure utilizing reflection between layers generated by partially increasing a difference in refractive index, a lens structure in which an uneven structure is appropriately disposed, and a light guide plate. Furthermore, since the ink composition of the present invention has a low dielectric constant, the ink composition can also be used for an insulating film of the above-described organic electroluminescent element or a touch sensor device such as a touch panel. Examples of the touch sensor device include an electrostatic capacitance type touch panel.

### EXAMPLES

Hereinafter, the present invention will be described based on Examples and Comparative Examples, but the present invention is not limited to these Examples.

### 1. Regarding Ink Compositions of Examples 1 to 32 and Comparative Examples 1 to 8

An ink composition was prepared by stirring components at a composition ratio illustrated in Table 1 until a uniform solution was obtained. Only in Comparative Example 5, an inorganic nanofiller was not uniformly dispersed but precipitated. Note that correspondence between abbreviations of the components and compound names/product names thereof is illustrated in Table 2.

TABLE 1A

| | | | Example | | | | | | | | | |
|---|---|---|---|---|---|---|---|---|---|---|---|---|
| | | | 1 | 2 | 3 | 4 | 5 | 6 | 7 | 8 | 9 | 10 |
| Reagent addition amount | Inorganic filler powder or | P-Zr | 62.8 | 35.0 | 72.8 | 58.0 | 49.8 | | | 62.6 | | 73.0 |
| [% by weight] | Inorganic filler dispersion | M-Zr#1 | | | | | | 50.0 | 63.9 | | 63.0 | |
| | | M-Zr#2 | | | | | | | | | | |
| | | M-Zr#3 | | | | | | | | | | |
| | | D-Zr | | | | | | | | | | |
| | Monofunctional monomer | THF-A | 27.2 | 54.9 | | | | | | 26.5 | | |
| | | FX-AO-MA | | | 18.0 | 32.9 | 39.9 | 39.9 | 24.3 | | 23.6 | |
| | | IBX-A | | | | | | | | | | 17.0 |
| | | L-A | | | | | | | | | | |
| | | CH-M | | | | | | | | | | |
| | | PxEG2-A | | | | | | | | | | |
| | | TCM-A | | | | | | | | | | |
| | Polyfunctional monomer | C12-2M | | | | | | | | | | |
| | | EG4-2A | | | | | | | | | | |
| | | EG9-2A | | | | | | | | | | |
| | | BisA-2EG5-2M | | | | | | | | | | |
| | | TcDDM-2A | | | | | | | | | | |
| | | TMPDAy | | | | | | | | | | |
| | | TMPTA | | | | | | | | | | |
| | | TMP-3EG2-TA | | | | | | | | | | |
| | | DGE-4A | | | | | | | | | | |
| | Polymerization initiator | Irg 1173 | 9.9 | 10.0 | 9.1 | 9.0 | 10.2 | 10.0 | 11.7 | 9.9 | 11.4 | 9.9 |
| | Sensitizer | UVS-581 | | | | | | | | | | |
| | | Thioxanthone | | | | | | | | | | |
| | Surfactant | F-477 | 0.1 | 0.1 | 0.1 | 0.1 | 0.1 | 0.1 | 0.1 | 1.0 | 2.0 | 0.1 |
| | Solvent | PGME | | | | | | | | | | |

TABLE 1B

| | | | Example | | | | | | | | | |
|---|---|---|---|---|---|---|---|---|---|---|---|---|
| | | | 11 | 12 | 13 | 14 | 15 | 16 | 17 | 18 | 19 | 20 |
| Reagent addition amount | Inorganic filler powder or | P-Zr | 73.0 | 72.9 | 73.0 | 72.9 | | | | | | |
| [% by weight] | Inorganic filler dispersion | M-Zr#1 | | | | | 49.9 | 49.9 | 50.1 | 49.9 | 49.7 | 50.0 |
| | | M-Zr#2 | | | | | | | | | | |
| | | M-Zr#3 | | | | | | | | | | |
| | | D-Zr | | | | | | | | | | |
| | Monofunctional monomer | THF-A | | | | | | | | | | |
| | | FX-AO-MA | | | | | 19.8 | 20.0 | 20.0 | 20.0 | 20.4 | 20.2 |
| | | IBX-A | | | | | | | | | | |
| | | L-A | 17.0 | | | | | | | | | |
| | | CH-M | | 17.1 | | | | | | | | |
| | | PxEG2-A | | | 17.0 | | | | | | | |
| | | TCM-A | | | | 16.8 | | | | | | |
| | Polyfunctional monomer | C12-2M | | | | | 20.2 | | | | | |
| | | EG4-2A | | | | | | 20.1 | | | | |
| | | EG9-2A | | | | | | | 19.8 | | | |
| | | BisA-2EG5-2M | | | | | | | | 20.0 | | |
| | | TcDDM-2A | | | | | | | | | 19.7 | |
| | | TMPDAy | | | | | | | | | | 19.9 |
| | | TMPTA | | | | | | | | | | |
| | | TMP-3EG2-TA | | | | | | | | | | |
| | | DGE-4A | | | | | | | | | | |
| | Polymerization initiator | Irg 1173 | 9.9 | 9.9 | 9.9 | 10.2 | 10.0 | 9.9 | 10.0 | 10.0 | 10.1 | 9.8 |
| | Sensitizer | UVS-581 | | | | | | | | | | |
| | | Thioxanthone | | | | | | | | | | |
| | Surfactant | F-477 | 0.1 | 0.1 | 0.1 | 0.1 | 0.1 | 0.1 | 0.1 | 0.1 | 0.1 | 0.1 |
| | Solvent | PGME | | | | | | | | | | |

TABLE 1C

| | | | Example | | | | | | | | | |
|---|---|---|---|---|---|---|---|---|---|---|---|---|
| | | | 21 | 22 | 23 | 24 | 25 | 26 | 27 | 28 | 29 | 30 |
| Reagent addition amount | Inorganic filler powder or | P-Zr | 50.1 | 49.7 | 49.8 | | | | | | | |
| [% by weight] | Inorganic filler dispersion | M-Zr#1 | | | | 45.0 | 45.1 | 45.0 | 45.0 | 44.8 | 44.8 | 44.8 |
| | | M-Zr#2 | | | | | | | | | | |
| | | M-Zr#3 | | | | | | | | | | |
| | | D-Zr | | | | | | | | | | |
| | Monofunctional monomer | THF-A | | | | | | | | | | |
| | | FX-AO-MA | | | | 16.9 | 17.2 | 16.4 | 14.9 | 18.6 | 18.0 | 18.2 |
| | | IBX-A | | | | | | | | 4.5 | | |
| | | L-A | | | | | | | | | | |
| | | CH-M | | | | | | | | | 5.1 | |
| | | PxEG2-A | | | | | | | | | | 5.0 |
| | | TCM-A | 19.9 | 20.4 | 19.9 | | | | | | | |
| | Polyfunctional monomer | C12-2M | | | | | | | | | | |
| | | EG4-2A | 10.1 | 9.8 | 10.1 | | | | 24.8 | | | |
| | | EG9-2A | | | | 23.0 | 22.8 | 23.4 | | 23.0 | 23.0 | 23.0 |
| | | BisA-2EG5-2M | | | | | | | | | | |
| | | TcDDM-2A | | | | | | | | | | |
| | | TMPDAy | | | | | | | | | | |
| | | TMPTA | 9.9 | | | 5.0 | | | | | | |
| | | TMP-3EG2-TA | | 10.0 | | | 4.9 | | | | | |
| | | DGE-4A | | | 10.2 | | | 5.0 | 5.2 | 7.1 | 7.0 | 7.0 |
| | Polymerization initiator | Irg 1173 | 9.9 | 10.0 | 9.9 | 10.0 | 9.9 | 10.1 | 10.0 | 1.9 | 2.0 | 1.9 |
| | Sensitizer | UVS-581 | | | | | | | | | | |
| | | Thioxanthone | | | | | | | | | | |
| | Surfactant | F-477 | 0.1 | 0.1 | 0.1 | 0.1 | 0.1 | 0.1 | 0.1 | 0.1 | 0.1 | 0.1 |
| | Solvent | PGME | | | | | | | | | | |

TABLE 1D

| | | | Example | | Comparative Example | | | | | | | |
|---|---|---|---|---|---|---|---|---|---|---|---|---|
| | | | 31 | 32 | 1 | 2 | 3 | 4 | 5 | 6 | 7 | 8 |
| Reagent addition amount | Inorganic filler powder or | P-Zr | | | | | 58.0 | | | | | |
| [% by weight] | Inorganic filler dispersion | M-Zr#1 | 45.0 | 45.0 | | | | | | | | |
| | | M-Zr#2 | | | 70.0 | 75.0 | | | | | | |
| | | M-Zr#3 | | | | | | 75.0 | | | | |
| | | D-Zr | | | | | | | 48.0 | | | |
| | Monofunctional monomer | THF-A | | | 23.9 | | 22.9 | | | | 56.3 | |
| | | FX-AO-MA | 19.4 | 18.5 | | 18.9 | | 18.9 | 41.9 | | | 46.1 |
| | | IBX-A | | | | | | | | | | |
| | | L-A | | | | | | | | 17.3 | | |
| | | CH-M | | | | | | | | | | |
| | | PxEG2-A | | | | | | | | | | |
| | | TCM-A | | | | | | | | | | |
| | Polyfunctional monomer | C12-2M | | | | | | | | 73.5 | | |
| | | EG4-2A | | | | | | | | | | |
| | | EG9-2A | 23.0 | 23.0 | | | | | | | | |
| | | BisA-2EG5-2M | | | | | | | | | | |
| | | TcDDM-2A | | | | | | | | | | |
| | | TMPDAy | | | | | | | | | | |
| | | TMPTA | 5.4 | 5.1 | | | | | | 8.0 | 42.2 | 52.0 |
| | | TMP-3EG2-TA | | | | | | | | | | |
| | | DGE-4A | | | | | | | | | | |
| | Polymerization initiator | Irg 1173 | 7.0 | 7.8 | 6.0 | 6.0 | 9.0 | 6.0 | 10.0 | 1.1 | 1.4 | 1.4 |
| | Sensitizer | UVS-581 | 0.1 | | | | | | | | | |
| | | Thioxanthone | | 0.1 | | | | | | | | |
| | Surfactant | F-477 | 0.1 | 0.5 | 0.1 | 0.1 | 0.1 | 0.1 | 0.1 | 0.1 | 0.1 | 0.5 |
| | Solvent | PGME | | | | | 10 | | | | | |

TABLE 2

| | Abbreviation | Compound name or product name |
|---|---|---|
| Inorganic filler powder or | P-Zr | The Clear Solution PCPN-80-BMT manufactured by Pixelligent Technologies, LLC |
| Inorganic filler dispersion | M-Zr#1 | #1976 manufactured by Mikuni Color Ltd. |
| | M-Zr#2 | B943M manufactured by Mikuni Color Ltd. |
| | M-Zr#3 | #1718 manufactured by Mikuni Color Ltd. |
| | D-Zr | UEP-100-ST1 manufactured by Daiichi Kigenso Kagaku Kogyo Co., Ltd. |
| Monofunctional monomer | THF-A | Tetrahydrofurfuryl acrylate (Light Acrylate THF-A manufactured by Kyoeisha |
| | | Chemical Co., Ltd.) |
| | FX-AO-MA | Methyl 2-allyloxymethyl acrylate (FX-AO-MA manufactured by Nippon Shokubai Co., |
| | | Ltd.) |
| | IBX-A | Isobornyl acrylate (Light Acrylate IB-X manufactured by Kyoeisha Chemical Co., |
| | | Ltd.) |
| | L-A | Lauryl acrylate (Light Acrylate L-A manufactured by Kyoeisha Chemical Co., Ltd.) |
| | CH-M | Cyclohexyl methacrylate (Light ester CH manufactured by Kyoeisha Chemical Co., |
| | | Ltd.) |
| | PxEG2-A | 2-Phenoxyethyl acrylate (SR339 manufactured by Sartomer) |
| | TCM-A | 3,3,5-Trimethylcyclohexanol acrylate (CD421 manufactured by Sartomer) |
| Polyfunctional monomer | C12-2M | Dodecanediol dimethacrylate (SR262 manufactured by Sartomer) |
| | EG4-2A | PEG 200# diacrylate (Light Acrylate 4EG-A manufactured by Kyoeisha Chemical Co., |
| | | Ltd.) |
| | EG9-2A | PEG 400# diacrylate (Light Acrylate 9EG-A manufactured by Kyoeisha Chemical Co., |
| | | Ltd.) |
| | BisA-2EG5-2M | EO-modified bisphenol A dimethacrylate (FA-321M manufactured by Hitachi Chemical |
| | | Co., Ltd.) |
| | TcDDM-2A | Tricyclodecanedimethanol diacrylate (IRR 214-K manufactured by Daicel-Allnex |
| | | Ltd.) |
| | TMPDAy | Trimethylolpropane diallyl ether (Neo Allyl T-20 manufactured by Osaka Soda Co., |
| | | Ltd.) |
| | TMPTA | Trimethylolpropane triacrylate (M-309 manufactured by Toagosei Co., Ltd.) |
| | TMP-3EG2-TA | Trimethylolpropane EO-modified triacrylate (M-360 manufactured by Toagosei Co., |
| | | Ltd.) |
| | DGE-4A | EO-modified diglycerin tetraacrylate (Light Acrylate DGE-4A manufactured by |
| | | Kyoeisha Chemical Co., Ltd.) |
| Polymerization initiator | Irg 1173 | Irgacure 1173 manufactured by BASF |
| Sensitizer | UVS-581 | UVS-581 manufactured by Kawasaki Kasei Kogyo Co., Ltd. |
| | Thioxanthone | Thioxanthone (purchased from Tokyo Chemical Industry) |
| Surfactant | F-477 | Megaface F-477 manufactured by DIC Corporation |
| Solvent | PGME | 1-Methoxy-2-propanol |

PCPN-80-BMT manufactured by Pixelligent Technologies, LLC Includes 79% by weight of a zirconium oxide filler having an average particle diameter (D₅₀) of 5 nm and 21% by weight of a monomer component (benzyl methacrylate and trimethylolpropane triacrylate).

#1976 manufactured by Mikuni Color Ltd. contains 49% by weight of a zirconium oxide filler having an average particle diameter (D₅₀) of 10 nm and 51% by weight of 2-([1,1′-biphenyl]-2-yloxy) ethyl acrylate.

B943M manufactured by Mikuni Color Ltd. contains 39% by weight of a zirconium oxide nanofiller having an average particle diameter (D₅₀) of 8 nm, 10% by weight of acrylate, and 51% by weight of 1-methoxy-2-propanol (PGME) as a solvent.

#1718 manufactured by Mikuni Color Ltd. contains 38% by weight of a zirconium oxide nanofiller having an average particle diameter (D₅₀) of 35 nm, 8% by weight of acrylate, and 54% by weight of 1-methoxy-2-propanol (PGME) as a solvent.

UEP-100-ST1 manufactured by Daiichi Kigenso Kagaku Kogyo Co., Ltd. consists of 100% by weight of a zirconium oxide nanofiller having an average particle diameter (D₅₀) of 740 nm, and does not contain an acrylate or a solvent.

### Measurement of Viscosity and Surface Tension

The viscosity at 25° C. and the surface tension at 25° C. of each of the ink compositions prepared in Examples 1 to 32 and Comparative Examples 1 to 4 and 6 to 8 were measured (Table 3). For the viscosity, the viscosity of each of the ink compositions at 25° C. was measured using a viscometer TV-22 available from Toki Sangyo Co., Ltd. or a rheometer MCR302 manufactured by Anton Paar GmbH. Any of the ink compositions in Examples had a viscosity within a preferable range capable of inkjet printing, and was expected to have good ejection stability. Meanwhile, the ink composition in Comparative Example 4 had a high viscosity, and was expected to have difficulty in inkjet printing.

### Manufacture of Cured Film

For each of the ink compositions prepared in Examples 1 to 32 and Comparative Examples 1 to 4 and 6 to 8, a cured film was manufactured by the following procedure. 0.5 to 1.0 mL of each of the prepared ink compositions was placed on a 40×40×0.75 mm Eagle XG glass, and a coating film was prepared by a spin coating method. Subsequently, the coating film was irradiated with UV using a belt conveyor conveying exposure machine (J-CURE 1500 manufactured by JATEC). Irradiation time was adjusted such that integrated energy was 2000 mJ/cm². A surface was exposed to light until tackiness disappeared to manufacture a cured film having a film thickness of 1 to 4 μm.

### Measurement of Total Light Transmittance and Haze

The total light transmittance and haze of each of the cured films thus manufactured were measured (Table 3). For measurement of the total light transmittance and haze, a haze meter (haze-gard plus manufactured by BYK Co., Ltd.) was used. Air was used as a reference. Each of the ink compositions in Examples exhibited high transmittance and a low haze value required for a sealing agent of an organic thin film device. Meanwhile, the ink compositions in Comparative Examples 1 to 4 had high haze values, and most of the ink compositions had low transmittance.

### Measurement of Refractive Index

Furthermore, the refractive index of each of the cured films was measured using FE-3000 manufactured by Otsuka Electronics Co., Ltd. and an Abbe type refractometer Abbemat manufactured by Anton Paar GmbH (Table 3). Each of the ink compositions in Examples exhibited a high refractive index required for a sealing agent of an organic thin film device. Meanwhile, each of the ink compositions in Comparative Examples 6 to 8 had a low refractive index.

TABLE 3A

| | | Example | | | | | | | | | |
|---|---|---|---|---|---|---|---|---|---|---|---|
| | | 1 | 2 | 3 | 4 | 5 | 6 | 7 | 8 | 9 | 10 |
| Content of | First component | 49.6 | 27.7 | 57.5 | 45.8 | 39.3 | 24.5 | 31.3 | 49.5 | 30.9 | 57.7 |
| each | (inorganic filler) | | | | | | | | | | |
| component | Second component | 40.4 | 62.3 | 33.3 | 45.1 | 50.4 | 65.4 | 56.9 | 39.6 | 55.7 | 32.3 |
| [% by | (monomer) | | | | | | | | | | |
| weight] | Third component | 9.9 | 10.0 | 9.1 | 9.0 | 10.2 | 10.0 | 11.7 | 9.9 | 11.4 | 9.9 |
| | (polymerization initiator) | | | | | | | | | | |
| | Solid concentration | 100 | 100 | 100 | 100 | 100 | 100 | 100 | 100 | 100 | 100 |
| | Solvent | 0.0 | 0.0 | 0.0 | 0.0 | 0.0 | 0.0 | 0.0 | 0.0 | 0.0 | 0.0 |
| Ink physical | Surface tension [mN/m] | 29.1 | 30.2 | 29.3 | 29.3 | 29.1 | 30.8 | 28.6 | 22.8 | 23.7 | 27.5 |
| properties | Viscosity [mPas] | 14.4 | 5.4 | 17.8 | 6.8 | 5.0 | 7.7 | 18.0 | 16.3 | 22.7 | 36.2 |
| Cured film | Refractive index [nD] | 1.71 | 1.65 | 1.71 | 1.69 | 1.67 | 1.73 | 1.71 | 1.71 | 1.70 | 1.72 |
| physical | @589 nm | | | | | | | | | | |
| properties | Total light transmittance | 91.8 | 92.4 | 91.7 | 91.9 | 92.3 | 91.2 | 91.5 | 92.0 | 91.7 | 91.9 |
| | [%] | | | | | | | | | | |
| | Haze [%] | 0.09 | 0.11 | 0.07 | 0.12 | 0.10 | 0.82 | 0.17 | 0.09 | 0.22 | 0.10 |
| | | Example | | | | | | | | | |
| | | 11 | 12 | 13 | 14 | 15 | 16 | 17 | 18 | 19 | 20 |
| Content of | First component | 57.7 | 57.6 | 57.7 | 57.6 | 24.5 | 24.5 | 24.5 | 24.5 | 24.4 | 24.5 |
| each | (inorganic filler) | | | | | | | | | | |
| component | Second component | 32.3 | 32.4 | 32.3 | 32.1 | 65.4 | 65.5 | 65.4 | 65.4 | 65.4 | 65.6 |
| [% by | (monomer) | | | | | | | | | | |
| weight] | Third component | 9.9 | 9.9 | 9.9 | 10.2 | 10.0 | 9.9 | 10.0 | 10.0 | 10.1 | 9.8 |
| | (polymerization initiator) | | | | | | | | | | |
| | Solid concentration | 100 | 100 | 100 | 100 | 100 | 100 | 100 | 100 | 100 | 100 |
| | Solvent | 0.0 | 0.0 | 0.0 | 0.0 | 0.0 | 0.0 | 0.0 | 0.0 | 0.0 | 0.0 |
| Ink physical | Surface tension [mN/m] | 26.9 | 30.1 | 31.2 | 30.1 | 28.1 | 27.9 | 29.5 | 28.4 | 29.9 | 30 |
| properties | Viscosity [mPas] | 31.7 | 23.2 | 41.6 | 28.3 | 14.1 | 17.3 | 24.6 | 38.5 | 21.2 | 12.7 |
| Cured film | Refractive index [nD] | 1.71 | 1.68 | 1.73 | 1.71 | 1.64 | 1.71 | 1.71 | 1.64 | 1.68 | 1.70 |
| physical | @589 nm | | | | | | | | | | |
| properties | Total light transmittance | 91.2 | 91 | 91.6 | 91.9 | 92.5 | 91.6 | 91.7 | 92.4 | 92 | 91.7 |
| | [%] | | | | | | | | | | |
| | Haze [%] | 0.28 | 0.1 | 0.1 | 0.1 | 0.82 | 0.13 | 0.16 | 0.11 | 0.15 | 0.65 |

TABLE 3B

| | | Example | | | | | | | | | |
|---|---|---|---|---|---|---|---|---|---|---|---|
| | | 21 | 22 | 23 | 24 | 25 | 26 | 27 | 28 | 29 | 30 |
| Content of | First component | 39.6 | 24.4 | 39.3 | 22.1 | 22.1 | 22.1 | 22.1 | 22.0 | 22.0 | 22.0 |
| each | (inorganic filler) | | | | | | | | | | |
| component | Second component | 50.4 | 65.5 | 50.7 | 67.9 | 67.9 | 67.8 | 67.9 | 76.0 | 75.9 | 76.0 |
| [% by | (monomer) | | | | | | | | | | |
| weight] | Third component | 9.9 | 10.0 | 9.9 | 10.0 | 9.9 | 10.1 | 10.0 | 1.9 | 2.0 | 1.9 |
| | (polymerization initiator) | | | | | | | | | | |
| | Solid concentration | 100 | 100 | 100 | 100 | 100 | 100 | 100 | 100 | 100 | 100 |
| | Solvent | 0.0 | 0.0 | 0.0 | 0.0 | 0.0 | 0.0 | 0.0 | 0.0 | 0.0 | 0.0 |
| Ink physical | Surface tension [mN/m] | 29.2 | 30.5 | 29.1 | 30.1 | 29 | 28.9 | 29.7 | 27.9 | 28 | 28.1 |
| properties | Viscosity [mPas] | 18.7 | 23.1 | 22.5 | 22.1 | 23.5 | 23.4 | 20.8 | 20.4 | 19.7 | 19.5 |
| Cured film | Refractive index [nD] | 1.67 | 1.65 | 1.66 | 1.65 | 1.64 | 1.64 | 1.66 | 1.65 | 1.63 | 1.63 |
| physical | @589 nm | | | | | | | | | | |
| properties | Total light transmittance | 92.1 | 92.0 | 92.2 | 91.5 | 91.4 | 91.8 | 91.6 | 91.6 | 91.6 | 91.8 |
| | [%] | | | | | | | | | | |
| | Haze [%] | 0.07 | 0.1 | 0.09 | 0.12 | 0.13 | 0.14 | 0.16 | 0.13 | 0.12 | 0.14 |

| | | Example | | Comparative Example | | | | | | | |
|---|---|---|---|---|---|---|---|---|---|---|---|
| | | 31 | 32 | 1 | 2 | 3 | 4 | 5 | 6 | 7 | 8 |
| Content of | First component | 22.1 | 22.1 | 27.3 | 29.3 | 45.8 | 28.5 | 48.0 | 0.0 | 0.0 | 0.0 |
| each | (inorganic filler) | | | | | | | | | | |
| component | Second component | 70.8 | 69.6 | 30.9 | 26.4 | 35.1 | 24.9 | 41.9 | 98.8 | 98.5 | 98.1 |
| [% by | (monomer) | | | | | | | | | | |
| weight] | Third component | 7.0 | 7.8 | 6.0 | 6.0 | 9.0 | 6.0 | 10.0 | 1.1 | 1.4 | 1.4 |
| | (polymerization initiator) | | | | | | | | | | |
| | Solid concentration | 100 | 100 | 64.3 | 61.8 | 90.0 | 59.5 | 100 | 100 | 100 | 100 |
| | Solvent | 0.0 | 0.0 | 35.7 | 38.3 | 10.0 | 40.5 | 0.0 | 0.0 | 0.0 | 0.0 |
| Ink physical | Surface tension [mN/m] | 30.7 | 24.6 | 26.2 | 27.5 | 26.9 | 30.2 | N.D. | 25.5 | 30.2 | 26.2 |
| properties | Viscosity [mPas] | 22.1 | 23.8 | 4.2 | 4.6 | 9.0 | 278 | N.D. | 9.1 | 11.2 | 6.9 |
| Cured film | Refractive index [nD] | 1.69 | 1.67 | 1.73 | 1.74 | 1.74 | 1.74 | N.D. | 1.51 | 1.52 | 1.51 |
| physical | @589 nm | | | | | | | | | | |
| properties | Total light transmittance | 91.0 | 90.7 | 87.5 | 88.1 | 91.1 | 70.1 | N.D. | 92.0 | 92.1 | 91.9 |
| | [%] | | | | | | | | | | |
| | Haze [%] | 0.22 | 0.20 | 1.86 | 1.75 | 1.39 | 4.88 | N.D. | 0.05 | 0.05 | 0.05 |

### Element Evaluation

### Example 22

An organic electroluminescent element having a layer structure of Ag (80 nm)/αNPD (56 nm)/Alq₃:C545T (25 nm)/Alq₃ (30 nm)/LiF (0.8 nm)/Al (2 nm)/Ag (20 nm) was manufactured on a glass substrate by a vacuum vapor deposition method (see: APPLIED PHYSICS LETTERS 88, 073517 (2006)). Subsequently, a silicon nitride film was manufactured with a film thickness of 100 nm by plasma CVD. Furthermore, the ink composition in Example 3 was applied onto the silicon nitride film by inkjet printing, and then exposed to light at 1000 mJ/cm² with an exposure machine to manufacture a cured film having a film thickness of 1 μm. Similarly, the three silicon nitride films and the three cured films of the ink composition in Example 3 were further alternately laminated to manufacture a barrier film having a film thickness of about 4 μm. All of the above barrier film forming steps were performed in a nitrogen atmosphere.

Note that the mixed layer of Alq₃ and C545T was formed by subjecting Alq₃ and C545T to vapor deposition at a weight ratio of 99:1. αNPD, C545T, and Alq₃ are compounds having the following chemical structures.

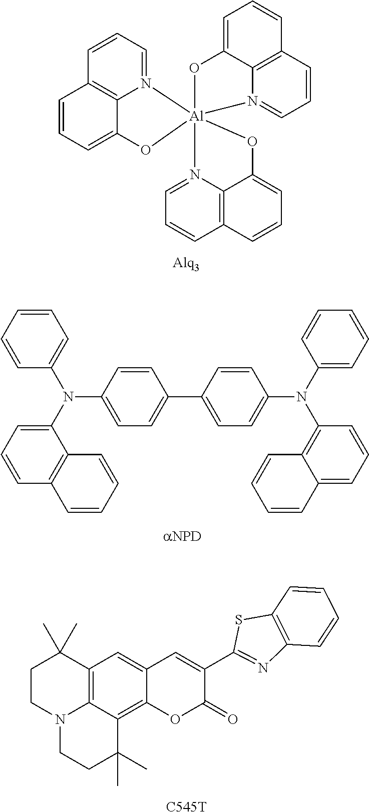

The manufactured element was turned on at 8 V in the atmosphere, and had a luminance of 850 cd/cm².

### Comparative Example 9

A barrier film was formed on the organic electroluminescent element by the same procedure as in Example 33 except that the ink composition in Comparative Example 3 was used. The manufactured element was turned on at 8 V in the atmosphere, and had a luminance of 780 cd/cm².

From the above results, it is found that the luminance in Example 33 was improved by 9% relative to that in Comparative Example 9.

### Evaluation of Folding Flexibility

The prepared ink composition was applied onto a film and exposed to light to manufacture a cured film. The cured film manufactured on the film was evaluated for folding flexibility with a mandrel testing machine.

### Example 34

The ink composition prepared in Example 3 was applied onto an adhesive layer of a polyethylene terephthalate film (COSMOSHINE A4100 manufactured by TOYOBO CO., LTD.) using a bar coater and exposed to light at an exposure intensity of 1000 mJ/cm² to manufacture a cured film having a thickness of 10 μm.

### Example 35

A cured film was manufactured on a film by a similar procedure to that in Example 34 except that the ink composition prepared in Example 6 was used.

### Example 36

A cured film was manufactured on a film by a similar procedure to that in Example 34 except that the ink composition prepared in Example 15 was used.

### Example 37

A cured film was manufactured on a film in a similar procedure to that in Example 34 except that the ink composition prepared in Example 16 was used.

### Example 38

A cured film was manufactured on a film by a similar procedure to that in Example 34 except that the ink composition prepared in Example 17 was used.

### Example 39

A cured film was manufactured on a film by a similar procedure to that in Example 34 except that the ink composition prepared in Example 21 was used.

### Example 40

A cured film was manufactured on a film by a similar procedure to that in Example 34 except that the ink composition prepared in Example 22 was used.

### Example 41

A cured film was manufactured on a film by a similar procedure to that in Example 34 except that the ink composition prepared in Example 23 was used.

### Comparative Example 10

A cured film was manufactured on a film by a similar procedure to that in Example 34 except that the ink composition prepared in Comparative Example 8 was used.

Evaluation was performed based on whether or not a cured film was cracked when the manufactured film with a cured film was folded once with a mandrel testing machine. The test was stopped when a crack was visually observed in a cured film. A mandrel diameter when no crack was observed is illustrated in Table 4. Note that the test was started at a mandrel diameter of 20 mm. In a case where cracking occurred in a test with a diameter of 20 mm, “>20” was described in a column of the mandrel diameter.

TABLE 4

| | Ink | Mandrel diameter [mm] |
|---|---|---|
| Example 34 | Example 3 | 10 |
| Example 35 | Example 6 | 10 |
| Example 36 | Example 15 | 10 |
| Example 37 | Example 16 | 8 |
| Example 38 | Example 17 | 6 |
| Example 39 | Example 21 | 10 |
| Example 40 | Example 22 | 4 |
| Example 41 | Example 23 | 4 |
| Comparative | Comparative | >20 |
| Example 10 | Example 8 | |

According to the results of the mandrel test, the cured film in Comparative Example 10 (ink composition of Comparative Example 8) had no flexibility and caused cracking by bending with a large diameter. Meanwhile, the cured products prepared in Examples 34 to 41 had high flexibility despite containing inorganic fillers. Furthermore, a composition including an EO-modified monomer or a monomer having an ethylene glycol skeleton obtained high flexibility. In a case where the polyfunctional monomer was an EO-modified monomer or a monomer having an ethylene glycol skeleton, for example, in Examples 38, 40, and 41, particularly high flexibility was obtained.

### 2. Regarding Ink Compositions in Examples 42 to 56 and Comparative Examples 11 to 13

An ink composition was prepared by stirring components at a composition ratio illustrated in Table 5 until a uniform solution (milky white transparent solution) was obtained. Only in Comparative Example 12, an inorganic nanofiller was not uniformly dispersed but precipitated. Note that correspondence between abbreviations of the components and compound names/product names thereof is illustrated in Table 6.

TABLE 5A

| | | | | | | | | Compar- | | | | |
|---|---|---|---|---|---|---|---|---|---|---|---|---|
| | | | | | | | | ative | | | | |
| | | | Exam- | Exam- | Exam- | Exam- | Exam- | Exam- | Exam- | Exam- | Exam- | Exam- |
| | | | ple 42 | ple 43 | ple 44 | ple 45 | ple 46 | ple 11 | ple 47 | ple 48 | ple 49 | ple 50 |
| Reagent | Inorganic filler | ZrO2/L-A | | | | | | | 50.0 | 40.0 | 25.0 | 25.0 |
| addition | dispersion | ZrO2/C12-2M | 53.6 | 65.8 | 53.6 | 54.0 | 54.0 | 54.0 | | | | |
| amount | Monofunctional | L-A | 12.1 | 11.2 | | | | | | | | |
| [% by | monomer | Iso C10-A | | | 12.1 | | | | | | | |
| weight] | | DcP-A | | | | 12.2 | | | | | | |
| | | IBX-A | | | | | 12.2 | | | | | |
| | | C4-A | | | | | | 12.2 | | | | |
| | Polyfunctional | C12-2M | 26.4 | 15.8 | 26.4 | 26.6 | 26.6 | 26.6 | | | | |
| | monomer | C9-2A | | | | | | | 39.0 | 49.0 | 64.0 | |
| | | TcDDM-2A | | | | | | | | | | 64.0 |
| | | Neo C5-2A | | | | | | | | | | |
| | | BisA-2E2-2A | | | | | | | | | | |
| | | EG9-2A | | | | | | | | | | |
| | | TMPTA | 5.7 | 5.3 | 5.7 | 5.8 | 5.8 | 5.8 | 10.0 | 10.0 | 10.0 | 10.0 |
| | | PE-4A | | | | | | | | | | |
| | | DPE-6A | | | | | | | | | | |
| | Polymerization | Irg 907 | 2.1 | 2.0 | 2.1 | 1.4 | 1.4 | 1.4 | 1.0 | 1.0 | 1.0 | 1.0 |
| | initiator | | | | | | | | | | | |

TABLE 5B

| | | | Example | Example | Comparative | Example | Comparative | Example | Example | Example |
|---|---|---|---|---|---|---|---|---|---|---|
| | | | 51 | 52 | Example 12 | 53 | Example 13 | 54 | 55 | 56 |
| Reagent | Inorganic filler | ZrO2/L-A | 25.0 | 25.0 | 25.0 | 25.0 | 25.0 | 17.7 | 50.0 | 50.0 |
| addition | dispersion | ZrO2/C12-2M | | | | | | | | |
| amount | Monofunctional | L-A | | | | | | 4.2 | | |
| [% by | monomer | Iso C10-A | | | | | | | | |
| weight] | | DcP-A | | | | | | | | |
| | | IBX-A | | | | | | | | |
| | | C4-A | | | | | | | | |
| | Polyfunctional | C12-2M | | | | | | | | |
| | monomer | C9-2A | | | | 64.0 | 64.0 | 66.7 | 44.0 | 49.0 |
| | | TcDDM-2A | | | | | | | | |
| | | Neo C5-2A | 64.0 | | | | | | | |
| | | BisA-2E2-2A | | 64.0 | | | | | | |
| | | EG9-2A | | | 64.0 | | | | | |
| | | TMPTA | 10.0 | 10.0 | 10.0 | | | 10.4 | 5.0 | |
| | | PE-4A | | | | 10.0 | | | | |
| | | DPE-6A | | | | | 10.0 | | | |
| | Polymerization | Irg 907 | 1.0 | 1.0 | 1.0 | 1.0 | 1.0 | 1.0 | 1.0 | 1.0 |
| | initiator | | | | | | | | | |

TABLE 6

| | Abbreviation | Compound name or product name |
|---|---|---|
| Inorganic filler dispersion | ZrO2/L-A | 49.6% by weight L-A dispersion of ZrO₂ (#2394 manufactured by Mikuni Color Ltd.) |
| | ZrO2/C12-2M | 50% by weight C12-2M dispersion of ZrO₂ |
| Monofunctional monomer | L-A | Lauryl acrylate (Light Acrylate L-A manufactured by Kyoeisha Chemical Co., Ltd.) |
| | Iso C10-A | Isodecyl acrylate (SR395 manufactured by Sartomer) |
| | DcP-A | Dicyclopentenyl acrylate (FANCRYL FA-511AS manufactured by Hitachi Chemical Co., |
| | | Ltd.) |
| | IBX-A | Isobornyl acrylate (Light Acrylate IB-X manufactured by Kyoeisha Chemical Co., |
| | | Ltd.) |
| | C4-A | Butyl acrylate (purchased from Tokyo Chemical Industry Co., Ltd.) |
| Polyfunctional monomer | C12-2M | Dodecanediol dimethacrylate (SR262 manufactured by Sartomer) |
| | C9-2A | Nonanediol diacrylate (Light acrylate 1.6ND-A manufactured by Kyoeisha Chemical |
| | | Co., Ltd.) |
| | TcDDM-2A | Tricyclodecanedimethanol diacrylate (IRR 214-K manufactured by Daicel-Allnex |
| | | Ltd.) |
| | Neo C5-2A | Neopentyl glycol diacrylate (Light Acrylate NP-A manufactured by Kyoeisha |
| | | Chemical Co., Ltd.) |
| | BisA-2E2-2A | EO-modified bisphenol A diacrylate (SR601 manufactured by Sartomer) |
| | EG9-2A | PEG 400# diacrylate (Light Acrylate 9EG-A manufactured by Kyoeisha Chemical Co., |
| | | Ltd.) |
| | TMPTA | Trimethylolpropane triacrylate (ARONIX M-309 manufactured by Toagosei Co., Ltd.) |
| | PE-4A | Pentaerythritol tetraacrylate (ARONIX M-450 manufactured by Toagosei Co., Ltd.) |
| | DPE-6A | Dipentaerythritol hexaacrylate (ARONIX M-405 manufactured by Toagosei Co., Ltd.) |
| Polymerization initiator | Irg 907 | Irgacure 907 manufactured by BASF |

#2394 manufactured by Mikuni Color Ltd. contains 49.6% by weight of a zirconium oxide filler having an average particle diameter (D₅₀) of 18 nm and 50.4% by weight of lauryl acrylate (L-A).

A dodecanediol dimethacrylate dispersion of a zirconium oxide filler (50% by weight C12-2M dispersion of ZrO₂) contains 50% by weight of a zirconium oxide filler having an average particle diameter (D₅₀) of 15 nm and 50% by weight of dodecanediol dimethacrylate (C12-2M), and was prepared by the following procedure.

10 g of a zirconium oxide nanofiller (TECNAPOW-ZRO2-100G manufactured by TECNAN S.L., particle diameter: 15 nm) and 1 g of oleyl phosphate were dissolved or dispersed in 1000 mL of pure water, 100 mL of toluene was further added thereto, and the resulting mixture was vigorously stirred at room temperature for one week. The toluene layer was collected, 10 g of dodecanediol dimethacrylate was added thereto, and then the resulting mixture was concentrated under reduced pressure while being heated at 70° C. to obtain milky white oil. The oil was further heated and dried at 70° C. under vacuum, and 20 g of a dodecanediol dimethacrylate dispersion of a zirconium oxide nanofiller was collected. A solid content concentration was calculated to be 50% by weight based on a charging ratio.

### Measurement of Viscosity and Surface Tension

Except for Comparative Example 12 in which the inorganic nanofiller was not uniformly dispersed but precipitated, the viscosity at 25° C. and the surface tension at 25° C. of each of the ink compositions prepared in Examples 42 to 56 and Comparative Examples 11 and 13 were measured. For the viscosity, the viscosity of each of the ink compositions at 25° C. was measured using a viscometer TV-22 available from Toki Sangyo Co., Ltd. or a rheometer MCR302 manufactured by Anton Paar GmbH. Any of the ink compositions in Examples had a viscosity within a preferable range capable of inkjet printing, and was expected to have good ejection stability.

### Manufacture of Cured Film

Except for Comparative Example 12 in which the inorganic nanofiller was not uniformly dispersed but precipitated, for each of the ink compositions prepared in Examples 42 to 56 and Comparative Examples 11 and 13, a cured film was prepared by the following procedure. 0.5 to 1.0 mL of each of the prepared ink compositions was placed on a 40×40×0.75 mm Eagle XG glass, and a coating film was prepared by a spin coating method. Subsequently, the resulting coating film was transferred into a glove box filled with nitrogen, and air mixed into the glove box was expelled by sufficiently flowing nitrogen. Thereafter, using an exposure machine (LIGHT SOURCE UL750 manufactured by HOYA Corporation, with a light guide drawn into the glove box), the coating film was irradiated with UV by adjusting irradiation time such that integrated energy was 150, 1000, or 1800 mJ/cm² to manufacture a cured film having a film thickness of 1 to 4 μm.

### Measurement of Total Light Transmittance and Haze

The total light transmittance and haze of each of the cured films thus manufactured were measured (Table 7). For measurement of the total light transmittance and haze, a haze meter (haze-gard plus manufactured by BYK Co., Ltd.) was used. Air was used as a reference. Each of the ink compositions in Examples exhibited high transmittance and a low haze value required for a sealing agent of an organic thin film device.

### Measurement of Refractive Index

The refractive index of each of the cured films was measured using FE-3000 manufactured by Otsuka Electronics Co., Ltd. (Table 7). Each of the ink compositions in Examples exhibited a high refractive index required for a sealing agent of an organic thin film device. Meanwhile, the ink composition in Comparative Example 13 had a low refractive index.

### Measurement of Dielectric Constant

A cured product was formed on a chromium-vapor-deposited glass substrate, and Al was further vapor-deposited on the cured product. Subsequently, a terminal of “LCR meter 4284A” manufactured by Agilent Technologies, Inc. was connected to the upper and lower chromium electrode and aluminum electrode of the cured product, and the electrostatic capacity at a frequency of 1 kHz was measured. The measured value was converted into a dielectric constant using the film thickness of the cured product and the electrode size. A dielectric constant (relative dielectric constant) ε is determined by formula 2. A vacuum dielectric constant ε₀ is 8.854×10⁻¹² [F/m], S represents the area of an electrode, d represents the film thickness of a cured product, and C represents an electrostatic capacity.

$$ɛ = C \times \frac{d}{S} \times \frac{1}{{ɛ}_{0}} \qquad ( Formula 2 )$$

TABLE 7A

| | | | | | | | Compar- | | | | |
|---|---|---|---|---|---|---|---|---|---|---|---|
| | | | | | | | ative | | | | |
| | | Exam- | Exam- | Exam- | Exam- | Exam- | Exam- | Exam- | Exam- | Exam- | Exam- |
| | | ple 42 | ple 43 | ple 44 | ple 45 | ple 46 | ple 11 | ple 47 | ple 48 | ple 49 | ple 50 |
| Content of | First component | 26.8 | 32.9 | 26.8 | 27.0 | 27.0 | 27.0 | 24.8 | 19.8 | 12.4 | 12.4 |
| each | (inorganic filler) | | | | | | | | | | |
| component | Second component | 71.0 | 65.2 | 71.0 | 71.6 | 71.6 | 71.6 | 74.2 | 79.2 | 86.6 | 86.6 |
| [% by | (monomer) | | | | | | | | | | |
| weight] | Third component | 2.1 | 2.0 | 2.1 | 1.4 | 1.4 | 1.4 | 1.0 | 1.0 | 1.0 | 1.0 |
| | (polymerization initiator) | | | | | | | | | | |
| | Solid concentration | 100 | 100 | 100 | 100 | 100 | 100 | 100 | 100 | 100 | 100 |
| | Solvent | 0.0 | 0.0 | 0.0 | 0.0 | 0.0 | 0.0 | 0.0 | 0.0 | 0.0 | 0.0 |
| Ink physical | Surface tension [mN/m] | 29.2 | 30.5 | 29.7 | 31.0 | 31.5 | 30.4 | 29.4 | 29.9 | 31.0 | 32.0 |
| properties | Viscosity [mPas] | 18.7 | 21.0 | 17.5 | 18.9 | 18.3 | 12.7 | 22.1 | 19.3 | 16.9 | 37.4 |
| Cured film | Refractive index [nD] | 1.65 | 1.70 | 1.66 | 1.65 | 1.65 | 1.65 | 1.68 | 1.70 | 1.73 | 1.65 |
| physical | @589 nm | | | | | | | | | | |
| properties | Total light transmittance | 89.8 | 88.5 | 89.1 | 89.9 | 90.2 | 91.0 | 89.8 | 90.1 | 90.2 | 88.9 |
| | [%] | | | | | | | | | | |
| | Haze [%] | 0.40 | 0.46 | 0.63 | 0.45 | 0.48 | 0.23 | 1.11 | 0.67 | 0.35 | 0.43 |
| | Dielectric constant @1 kHz | 3.38 | 3.50 | 3.42 | 3.45 | 3.32 | 4.10 | 3.83 | 3.80 | 3.67 | 3.71 |
| Solubility | δD | 14.6 | 14.6 | 14.5 | 14.8 | 14.7 | 14.5 | 16.3 | 16.4 | 16.4 | 16.9 |
| parameter | δP | 3.0 | 3.0 | 3.0 | 3.1 | 3.0 | 3.3 | 3.5 | 3.6 | 3.7 | 3.8 |
| | δH | 3.8 | 3.8 | 3.8 | 3.9 | 3.7 | 4.1 | 4.7 | 4.9 | 5.1 | 4.2 |
| | SP | 15.4 | 15.4 | 15.3 | 15.6 | 15.4 | 15.5 | 17.4 | 17.4 | 17.5 | 17.8 |

TABLE 7B

| | | Example | Example | Comparative | Example | Comparative | Example | Example | Example |
|---|---|---|---|---|---|---|---|---|---|
| | | 51 | 52 | Example 12 | 53 | Example 13 | 54 | 55 | 56 |
| Content of | First component | 12.4 | 12.4 | 12.4 | 12.4 | 12.4 | 8.8 | 24.8 | 24.8 |
| each | (inorganic filler) | | | | | | | | |
| component | Second component | 86.6 | 86.6 | 86.6 | 86.6 | 86.6 | 90.2 | 74.2 | 74.2 |
| [% by | (monomer) | | | | | | | | |
| weight] | Third component | 1.0 | 1.0 | 1.0 | 1.0 | 1.0 | 1.0 | 1.0 | 1.0 |
| | (polymerization initiator) | | | | | | | | |
| | Solid concentration | 100 | 100 | 100 | 100 | 100 | 100 | 100 | 100 |
| | Solvent | 0.0 | 0.0 | 0.0 | 0.0 | 0.0 | 0.0 | 0.0 | 0.0 |
| Ink physical | Surface tension [mN/m] | 30.5 | 31.8 | — | 31.1 | 31.1 | 29.9 | 31.5 | 31.4 |
| properties | Viscosity [mPas] | 22.7 | 43.2 | — | 24.0 | 36.6 | 20.8 | 39.6 | 35.1 |
| Cured film | Refractive index [nD] | 1.65 | 1.65 | — | 1.66 | 1.58 | 1.67 | 1.70 | 1.70 |
| physical | @589 nm | | | | | | | | |
| properties | Total light transmittance | 89.5 | 88.6 | — | 89.0 | 90.3 | 90.8 | 90.4 | 90.3 |
| | [%] | | | | | | | | |
| | Haze [%] | 0.44 | 0.57 | — | 0.57 | 0.45 | 0.91 | 0.72 | 0.74 |
| | Dielectric constant @1 kHz | 3.55 | 4.55 | — | 3.80 | 3.91 | 3.71 | 3.90 | 3.86 |
| Solubility | δD | 16.2 | 17.1 | 15.0 | 16.4 | 16.4 | 16.4 | 16.3 | 16.3 |
| parameter | δP | 3.9 | 5.3 | 6.1 | 3.7 | 3.6 | 3.7 | 3.5 | 3.5 |
| | δH | 5.4 | 5.5 | 7.3 | 5.1 | 5.0 | 5.1 | 4.7 | 4.6 |
| | SP | 17.6 | 18.7 | 17.8 | 17.6 | 17.6 | 17.5 | 17.3 | 17.3 |

### Evaluation of Inkjet Ejectability and Printability

An evaluation procedure of inkjet ejectability and printability for an ink composition will be described. Ejectability is evaluated by observing the flying shape of a droplet of an ink composition from an ejection hole of an inkjet and the state of adhesion of a droplet to the periphery of the ejection hole using a camera installed in an apparatus. Printability is evaluated by observing spreading of a droplet and connection between droplets for an ink composition used for drawing. Printability can also be evaluated by observing the shape of an end of a drawing portion or the like of the cured film obtained by photo-curing after drawing with an optical microscope or the like.

### Evaluation of Shape, Smoothness, and Planarity of Cured Product

The shape, smoothness, and planarity of an end of a drawing portion of the obtained cured product can be observed with an optical interference film thickness meter (Veeco NT-1100 or the like), a stylus film thickness meter (KLATencor P-16+), or a probe microscope (for example, an atomic force microscope (AFM)).

Specifically, for example, evaluation is performed by the following procedure, but an evaluation method may be arbitrarily added as necessary.

An ink composition is injected into an inkjet cartridge (model number: DMC-11610, ejection amount: 10 pL, manufactured by FUJIFILM Dimatix, Inc.), and the inkjet cartridge is set in an inkjet apparatus DMP-2811 (trade name, manufactured by Dimatix, Inc.). An ejection hole is observed with a camera of the apparatus, and the flying shape of an ink composition droplet that has been ejected is observed. Subsequently, drawing is performed on a glass substrate or a glass substrate having a SiNx film while an interval (dpi) between dots is gradually changed. After drawing is completed, spreading of a droplet is observed. Subsequently, the droplets are exposed to light to manufacture a cured film. An end of the obtained cured film is observed with an optical microscope and a stylus film thickness meter.

### INDUSTRIAL APPLICABILITY

The ink composition of the present invention can form a cured film excluding a solvent expected to deteriorate an organic thin film device, having good ejection stability of inkjet, and having excellent refractive index, transmittance, flexibility, and dielectric constant. Therefore, the ink composition of the present invention can be used as a sealing agent for an organic thin film device such as an organic electroluminescent element, a transparent insulating film, an overcoat, or the like. For example, the ink composition of the present invention can improve a light extraction efficiency, which is an object of a top emission type organic electroluminescent element as a main stream in recent years.

### REFERENCE SIGNS LIST

100 Organic electroluminescent element
101 Substrate
102 Positive electrode
103 Hole injection layer
104 Hole transport layer
105 Light emitting layer
106 Electron transport layer
107 Electron injection layer
108 Negative electrode
109 Capping layer
110 Bank
111 Barrier layer
112 Adhesive layer
113 Barrier film
121 Passivation layer
122 Buffer layer
130 Single barrier layer
200 Organic electroluminescent element having laminated barrier layer
300 Organic electroluminescent element having laminated barrier layer
400 Organic electroluminescent element having single barrier layer

1. An ink composition comprising:
as a first component, at least one inorganic filler selected from the group consisting of zirconium oxide, titanium oxide, hafnium oxide, barium titanate, boron nitride, and cerium oxide, having an average particle diameter of 1 to 30 nm;
as a second component, at least one monomer selected from (meth)acrylate-based monomers; and
as a third component, at least one polymerization initiator, wherein
a total weight concentration of the first to third components is 98 to 100% by weight relative to a total weight of the ink composition.

2. The ink composition according to claim 1, wherein the first component is zirconium oxide.

3. The ink composition according to claim 1, wherein the (meth)acrylate-based monomer as the second component has at least one selected from the group consisting of an alkyl group, an alkenyl group, an ether group, and an aryl group.

4. The ink composition according to claim 1, wherein the (meth)acrylate-based monomer as the second component contains at least one selected from the following compound group (2-a) and at least one selected from compound group (2-b).
Compound group (2-a): monofunctional (meth)acrylate-based monomer
Compound group (2-b): polyfunctional (meth)acrylate-based monomer, polyfunctional allyl ether-based monomer, and polyfunctional allyl ester-based monomer

5. The ink composition according to claim 4, wherein the compound of the compound group (2-a) has a molecular weight of 100 to 300.

6. The ink composition according to claim 5, wherein the compound of the compound group (2-a) is a compound having a (meth)acrylate moiety and an alkyl group or a cycloalkyl group having 6 to 16 carbon atoms, at least one —CH₂— in the alkyl group or the cycloalkyl group may be replaced by —O—, —CO—, —COO—, —OCO—, or —OCOO—, and at least one —(CH₂)₂— may be replaced by —CH═CH— or —C≡C—.

7. The ink composition according to claim 5, wherein the compound of the compound group (2-a) is at least one selected from the group consisting of tetrahydrofurfuryl (meth)acrylate, alkoxylated tetrahydrofurfuryl (meth)acrylate, 2-(allyloxymethyl) methyl (meth)acrylate, 2-(2-vinyloxyethoxy) ethyl (meth)acrylate, 2-hydroxyethyl (meth)acrylate, 2-hydroxypropyl (meth)acrylate, 4-hydroxybutyl (meth)acrylate, isobornyl (meth)acrylate, lauryl (meth)acrylate, cyclohexyl (meth)acrylate, 2-phenoxyethyl (meth)acrylate, 3,3,5-trimethylcyclohexanol (meth)acrylate, isodecyl (meth)acrylate, dicyclopentenyl (meth)acrylate, adamantyl (meth)acrylate, and tridecanyl (meth)acrylate.

8. The ink composition according to claim 5, wherein the compound of the compound group (2-a) is a compound having a (meth)acrylate moiety and an alkyl group or a cycloalkyl group having 6 to 16 carbon atoms, and at least one —(CH₂)₂— in the alkyl group or the cycloalkyl group may be replaced by —CH═CH— or —C≡C—.

9. The ink composition according to claim 5, wherein the compound of the compound group (2-a) is at least one selected from the group consisting of isobornyl (meth)acrylate, lauryl (meth)acrylate, cyclohexyl (meth)acrylate, 3,3,5-trimethylcyclohexanol (meth)acrylate, isodecyl (meth)acrylate, dicyclopentenyl (meth)acrylate, adamantyl (meth)acrylate, and tridecanyl (meth)acrylate.

10. The ink composition according to claim 4, wherein the compound of the compound group (2-b) has a molecular weight of 200 to 1000.

11. The ink composition according to claim 10, wherein the compound of the compound group (2-b) has 4 to 10 oxygen atoms in a molecule thereof.

12. The ink composition according to claim 10, wherein the compound of the compound group (2-b) is at least one selected from the group consisting of dodecanediol di(meth)acrylate, polyethylene glycol di(meth)acrylate, EO-modified bisphenol A di(meth)acrylate, EO-modified bisphenol F di(meth)acrylate, tricyclodecanedimethanol di(meth)acrylate, trimethylolpropane diallyl ether, trimethylolpropane tri(meth)acrylate, trimethylolpropane EO-modified tri(meth)acrylate, EO-modified diglycerin tetra(meth)acrylate, nonanediol di(meth)acrylate, neopentyl glycol di(meth)acrylate, EO-modified trimethylolpropane tri(meth)acrylate, ditrimethylolpropane tetra(meth)acrylate, glycerol tri(meth)acrylate, diglycerin tetra(meth)acrylate, pentaerythritol tri(meth)acrylate, pentaerythritol tetra(meth)acrylate, dipentaerythritol hexa(meth)acrylate, decanediol di(meth)acrylate, isocyanuric acid EO-modified di(meth)acrylate, isocyanuric acid EO-modified tri(meth)acrylate, tris[(meth)acryloxyethyl] isocyanurate, and polybutadiene di(meth)acrylate.

13. The ink composition according to claim 10, wherein the compound of the compound group (2-b) is at least one selected from the group consisting of dodecanediol di(meth)acrylate, tricyclodecanedimethanol di(meth)acrylate, trimethylolpropane diallyl ether, nonanediol di(meth)acrylate, neopentyl glycol di(meth)acrylate, decanediol di(meth)acrylate, and polybutadiene di(meth)acrylate.

14. The ink composition according to claim 1, wherein the monomer as the second component has Hansen solubility parameters (δD, δP, and δH) of δD: 13.0 to 18.0, δP: 2.0 to 6.0, and δH: 2.0 to 6.0.

15. The ink composition according to claim 1, wherein
relative to a solid component in the ink composition,
the first component has a content of 5.0 to 60.0% by weight,
the second component has a content of 25.0 to 94.0% by weight, and
the third component has a content of 1.0 to 15.0% by weight.

16. The ink composition according to claim 1, comprising at least one photosensitizer as a fourth component.

17. The ink composition according to claim 1, comprising at least one surfactant as a fifth component.

18. The ink composition according to claim 1, having a viscosity of 1 to 50 mPa·s at 25° C. and a surface tension of 15 to 35 mN/m at 25° C.

19. A cured product formed using the ink composition according to claim 1, having a refractive index of 1.6 to 2.0 after curing.

20. A cured product formed using the ink composition according to claim 1, having a dielectric constant of 1.5 to 4.6 after curing.

21. A display element comprising the cured product according to claim 19.

22. A touch sensor device comprising the cured product according to claim 19.

23. A light extraction structure comprising the cured product according to claim 19.

24. An organic thin film device comprising a barrier layer, wherein the barrier layer is a laminate of a layer formed of the following compound group (P-1) and a layer formed of compound group (P-2).
Compound group (P-1): at least one compound selected from the group consisting of silicon nitride, silicon nitride oxide, silicon nitride carbide, silicon nitride oxide carbide, and aluminum oxide
Compound group (P-2): a cured product manufactured using the ink composition according to claim 1.

25. The organic thin film device according to claim 24, which is an organic electroluminescent element.

26. A method for manufacturing the organic thin film device according to claim 24.
